(19) United States
(12) Patent Application Publication
(10) Pub. No.: US 2012/0191653 A1
(43) Pub. Date: Jul. 26, 2012

(54) DOCUMENT DISTRIBUTION SYSTEM

(75) Inventor: Kazuhiro Ogura, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/353,446

(22) Filed: Jan. 19, 2012

Related U.S. Application Data
(60) Provisional application No. 61/434,906, filed on Jan. 21, 2011.

(51) Int. Cl. G06F 7/00

(52) U.S. Cl. 707/636; 707/E17.005; 707/E17.032; 707/E17.008

(57) ABSTRACT

According to one embodiment, a server apparatus includes a first storing section, a second storing section, an input section, a third storing section, and a distributing section. The first storing section stores document data. The second storing section stores information indicating a distribution ID of the document data. The input section receives replacement information indicating replaced content if old document data stored by the first storing section is replaced with new document data. The third storing section stores the replacement information received by the input section in association with the new document data. The distributing section distribute the new document data and the replacement information, in response to a request from an apparatus which has the distribution ID.

### CROSS-REFERENCE TO RELATED APPLICATIONS

This application is based upon and claims the benefit of priority from U.S. Provisional Application No. 61/434,906 filed on Jan. 21, 2011; the entire contents of which are incorporated herein by reference.

### FIELD

Embodiments described herein relate generally to a server apparatus used in a document distribution system.

### BACKGROUND

A document distribution system is a system that electronically distributes a document to plural users. However, in a document distribution system in the past, if replacement occurs in a document to be distributed, it is difficult to plainly inform users of a replaced page, a corrected portion of the replaced page, or the like.

### BRIEF DESCRIPTION OF THE DRAWINGS

FIG. 1 is a schematic diagram of a configuration example of a document distribution system;

FIG. 2 is a block diagram of a configuration example of control systems in a user terminal and a management server;

FIG. 3 is a diagram of a configuration example of a job file that stores a document;

FIG. 4 is a diagram of a configuration example of a job management database;

FIG. 5 is a diagram of a configuration example of a meeting setting database;

FIG. 6 is a diagram of a configuration example of a group setting database;

FIG. 7 is a flowchart for explaining upload processing for a document by the user terminal;

FIG. 8 is a diagram of a display example of a printing setting screen displayed on a display section of the user terminal;

FIG. 9 is a diagram of a display example of a distribution setting screen for a document to be uploaded;

FIG. 10 is a diagram of a display example of a meeting ID search screen;

FIG. 11 is a diagram of a display example of a group selection screen;

FIG. 12 is a diagram of a setting example of distribution setting information;

FIG. 13 is a diagram of a display example of replacement information input on the distribution setting screen;

FIG. 14 is a flowchart for explaining a flow of registration processing for a document in the management server;

FIG. 15 is a diagram of a display example of a login screen displayed on a Web;

FIG. 16 is a diagram of a display example of a selection screen for document data displayed on the Web;

FIG. 17 is a diagram of a display example of a distribution designation screen for the document data displayed on the Web;

FIG. 18 is a diagram of a display example of an image creation screen for creating an illustration image of a changed portion;

FIG. 19 is a diagram of an example of a page image on which the illustration image of the changed portion is superimposed;

FIG. 20 is a diagram of an example of the illustration image of the changed portion displayed to be superimposed on the page image;

FIG. 21 is a diagram of a configuration example of a history database;

FIG. 22 is a flowchart for explaining a flow of download notification processing by the management server;

FIG. 23 is a flowchart for explaining the flow of the download processing by the management server;

FIG. 24 is a flowchart for explaining a flow of download processing for document data by the user terminal;

FIG. 25 is a flowchart for explaining a flow of viewing processing for a document in the user terminal;

FIG. 26 is a display example of a document selection screen on which a list of documents that a user can view is displayed;

FIG. 27 is a diagram of a display example of an update guideline;

FIG. 28 is a diagram of a display example in which a page image of an updated page is displayed;

FIG. 29 is a flowchart for explaining a flow of replacement notification processing in the management server that displays a document data on a Web page; and

FIG. 30 is a flowchart for explaining a flow of display processing and viewing management processing for a document on the Web page.

### DETAILED DESCRIPTION

In general, according to one embodiment, a server apparatus includes a first storing section, a second storing section, an input section, a third storing section, and a distributing section. The first storing section stores document data. The second storing section stores information indicating a distribution ID of the document data. The input section receives replacement information indicating replaced content if old document data stored by the first storing section is replaced with new document data. The third storing section stores the replacement information received by the input section in association with the new document data. The distributing section distribute the new document data and the replacement information, in response to a request from an apparatus which has the distribution ID.

An embodiment is explained in detail below with reference to the accompanying drawings.

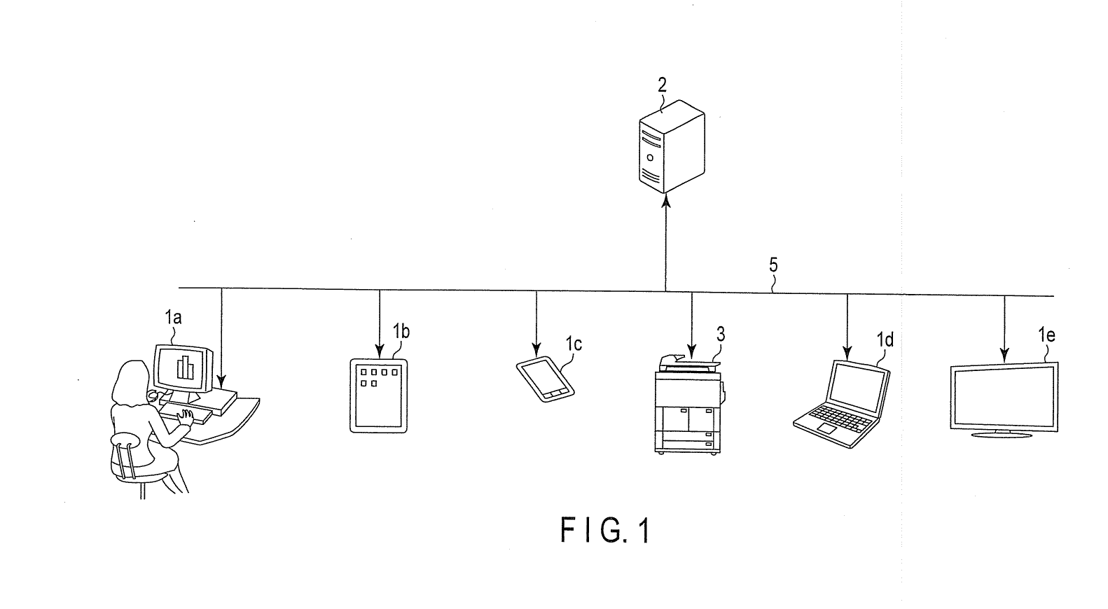

FIG. 1 is a schematic diagram of a configuration example of a document distribution system.

In the configuration example shown in FIG. 1, the document distribution system includes plural user terminals 1 (1a, 1b, 1c, 1d, and 1e), a management server 2, and an image forming apparatus (a printer) 3. In the document distribution system, the user terminals 1, the management server 2, and the image forming apparatus 3 are connected via a network 5. The network 5 is constructed by wired or wireless communication. The network 5 is not limited to a network in a local area. For example, the network 5 may include a wide area network such as the Internet.

In the document distribution system, the user terminal 1 operated by a certain user uploads, to the management server 2, document data that should be distributed to other users. The management server 2 registers the document data uploaded from the user terminal 1. The management server 2 sets, as a distribution ID (distribution destination) of the document data to be registered, the user designated in the user terminal 1. The management server 2 downloads the registered document data to the user terminal 1 of the user set as the distribution ID. The user terminal 1 provides the user with the document data downloaded from the management server 2.

The user terminal 1 is a terminal apparatus used by the user. The user terminal 1 only has to be an apparatus that can perform communication via the network 5. For example, the user terminal 1 may be a personal computer such as a desktop personal computer 1a or a notebook personal computer 1b. The user terminal 1 may be a portable electronic apparatus such as a tablet computer 1b, a smart phone 1c, or a cellular phone. Further, the user terminal 1 may be a television 1e, a video recorder, or the like including a network communication function.

The user terminals 1 include a function of providing users designated as distribution ID with a document registered in the management server 2 (a function of allowing the users to view the document). For example, the user terminal 1 downloads, from the management server 2, a document that a user specified by a user identification function can view and displays the document. The user terminal 1 may log in to the management server 2 with a Web browser and display, with the Web browser, a document that a logged-in user can view.

A user who distributes (provides) a document to the other users (an owner of the document) performs, with the user terminal 1, operation for registering the document to be distributed to the other users in the management server 2. The user terminal 1 performs, according to the operation by the user, upload processing for uploading job data including the document to the management server 2 as data for registration. For example, the user terminal 1 uploads, with a function provided by a printer driver associated with the management server 2, the document to be distributed to the other users to the management server 2. Upload processing for the document to be distributed to the other users and processing such as designation of distribution ID of the document may be realized on a Web page provided by a management server accessible by a Web browser installed in the user terminal 1. Further, the user terminal 1 may carry out registration of the document (a job including document data) with the printer driver and carry out processing such as distribution setting and replacement setting for the registered document with the Web browser.

The management server 2 includes a server computer. The management server 2 includes a function of communicating with the user terminals 1 and the image forming apparatus 3 via the network 5. The management server 2 registers, as a job file associated with a user ID, a document uploaded from the user terminal 1. The management server 2 includes a function of setting users as distribution ID of the document registered as the job file. The management server 2 includes a function of providing, according to the setting of the distribution ID, the registered document of the job file such that the users set as the distribution ID can view the document. A form of distributing the document may be a form of downloading document data to the user terminals 1 of the users set as the distribution ID or may be a form of causing the user terminals 1, to which the users set as the distribution ID log in, to display the document with the Web browser.

The image forming apparatus 3 includes, for example, a digital multifunction peripheral (MFP). The image forming apparatus 3 includes a printer function, a network communication function, and a user identification (user authentication) function. The image forming apparatus 3 includes, as print functions, a function of printing document data directly transferred from the user terminal 1 and a function of printing document data registered in the management server 2.

The image forming apparatus 3 determines user identification information for specifying a user with the user identification function. The user identification information only has to be information with which user associated with a job by the management server 2 can be distinguished. For example, the user identification information may be a user ID or may be information obtained as a result of user authentication processing by authentication information such as a password or biological information. The image forming apparatus 3 includes a function of downloading, from the management server 2, a job that the user specified by the user identification function can execute. The image forming apparatus 3 may operate as the user terminal 1 of the user specified by the user identification function.

The configurations of control systems in the user terminal 1 and the management server 2 are explained.

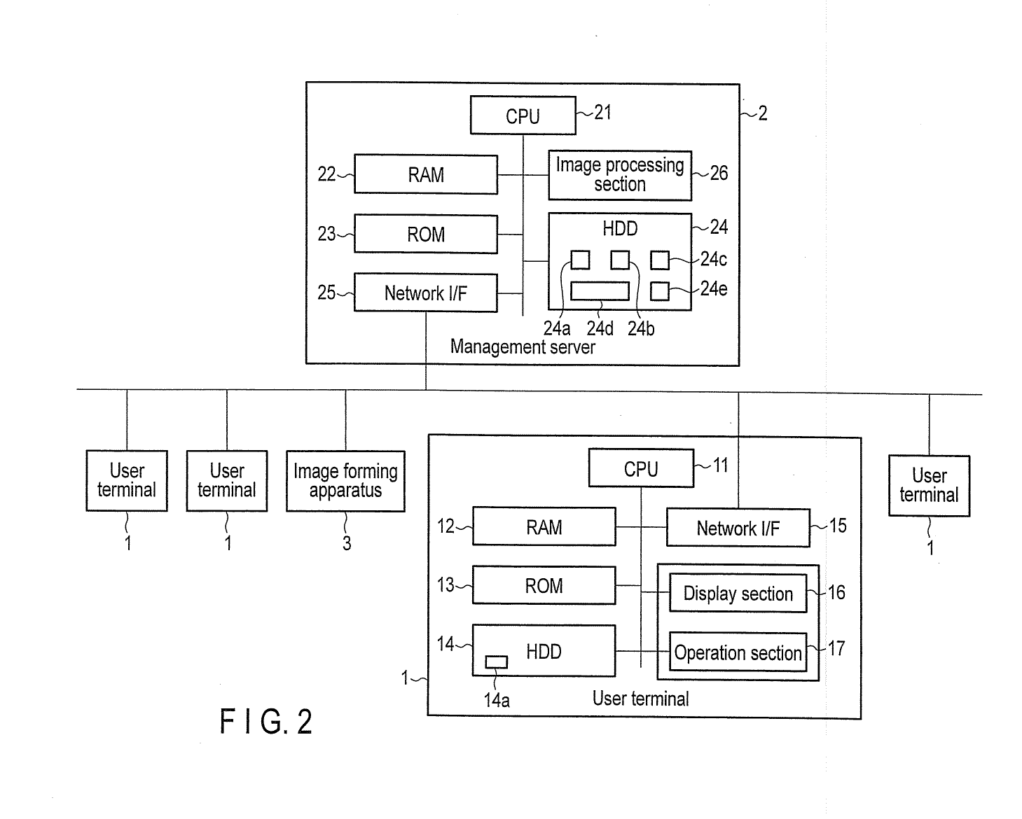

FIG. 2 is a block diagram of a configuration example of the control systems in the user terminal 1 and the management server 2.

First, the configuration of the user terminal 1 is explained.

Each of the user terminals 1 includes, as shown in FIG. 2, a processor (CPU) 11, a RAM 12, a ROM 13, a HDD 14, a network interface (I/F) 15, a display section 16, and an operation section 17.

The processor 11 is, for example, a CPU. The processor 11 manages the control of the entire user terminal 1. The processor 11 executes computer programs stored in the ROM 13 or the HDD 14 to thereby realize various processing functions. For example, an application program such as the printer driver or the Web browser is installed in the HDD 14 or the ROM 13 and executed by the processor 11.

The RAM 12 is a nonvolatile memory. The RAM 12 functions as a working memory and also functions as, for example, a buffer memory that temporarily stores data for work. The ROM 13 stores a control program, control data, and the like for managing the basic operation of the user terminal 1.

The HDD 14 is a storage device for data storage. For example, the HDD 14 stores data (e.g., document data including images of pages) of a document to be distributed to the other users, an application program (e.g., a printer driver for the image forming apparatus 3, a printer driver for the management server 2, or a Web browser) executed by the processor 11, and data for user authentication.

The HDD 14 includes a user history database 14a. The user history database 14a stores information such as a download situation and a viewing situation (viewing history information) for document data to be distributed.

The network interface 15 is an interface for performing data communication with the apparatuses in the network 5. The display section 16 displays document data (page images of a document) and the like and displays operation guidance and the like. For example, the display section 16 displays document data distributed from the management server 2. The display section 16 displays various setting screens for performing upload of job data including document data, setting of distribution ID of a document, designation of replacement of the document, and the like. The operation section 17 is a section with which the user inputs information.

The operation section 17 includes a keyboard and a mouse or a touch panel provided in the display section 16. For example, if the user terminal 1 is a portable electronic apparatus such as a tablet terminal or a smart phone, the display section 16 and the operation section 17 may include a liquid crystal display device incorporating a touch panel.

In the user terminal 1, the processor 11 executes a computer program to realize the user identification function. The user identification function may be a function of acquiring user information input by the user in startup processing or login processing or may be a function of acquiring user information obtained as a result of user authentication by authentication information such as a password. In the document distribution system according to this embodiment, each of the user terminals 1 includes a function of identifying a user who is a user of the apparatus.

In the user terminal 1, the processor 11 includes a function of executing the printer driver for the image forming apparatus 3 to thereby transmit print data to the image forming apparatus 3. The processor 11 executes a computer program for the document distribution system (the printer driver for the management server 2 or the Web driver) to thereby upload document data to the management server 2 and perform designation of distribution ID, replacement designation, or the like for the document data.

The configuration of the management server 2 is explained.

The management server 2 includes, as shown in FIG. 2, a processor (CPU) 21, a RAM 22, a ROM 23, a HDD 24, a network interface (I/F) 25, and an image processing section 26.

The processor 21 is, for example, a CPU. The processor 21 manages control of the entire server 2. The processor 21 executes computer programs stored in the ROM 23 or the HDD 24 to thereby realize various processing functions. For example, the processor 21 executes the computer programs to realize a function of registering, as a job file, job data including document data supplied from the user terminal 1 and a function of distributing the registered document data to designated distribution ID.

The RAM 22 is a volatile memory. The RAM 22 functions as a working memory and also functions as, for example, a buffer memory that temporarily stores work data. The ROM 23 stores a control program, control data, and the like for managing the basic operation of the server 2. The HDD 24 is a storage device for data storage. The HDD 24 stores a job file including document data to be distributed and management information for managing the job file. The HDD 24 stores an application program executed by a processor 21 for realizing a registration function and a management function for a document. The network interface 25 is an interface for performing data communication with the apparatuses in the network 5.

The image processing section 26 converts pages of a document into image data (e.g., image data of the JPEG format). For example, the image processing section 26 subjects pages of document data transmitted as vector data (PDL) for print from the user terminal 1 to RIP and converts the pages into raster images. The processor 21 stores the pages of the document data generated by the image processing section 26 in a job file as page images for display.

The HDD 24 includes a storage area for storing a job file including document data and various databases for managing the job file (the document data). For example, the HDD 24 includes a job storing section 24a, a job management database 24b, a meeting setting database 24c, a group setting database 24d, and a history database 24e. The job storing section 24a stores the job file including the document data. For example, if document data is uploaded from the user terminal 1, the job storing section 24a stores a job file that stores the document data. A job ID serving as identification information for identifying a job is issued to the job file stored in the job storing section 24a.

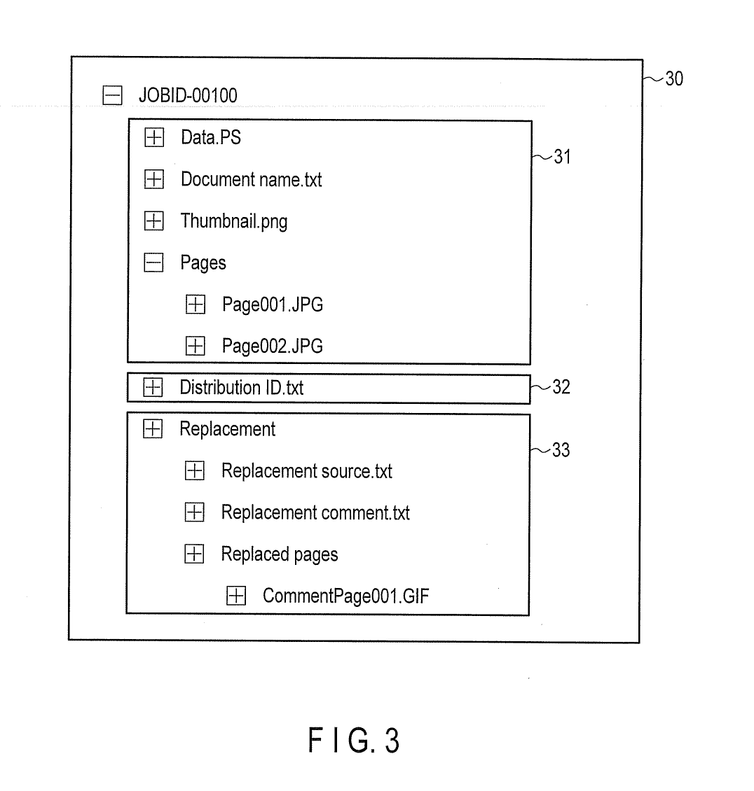

FIG. 3 is a diagram of a configuration example of a job file (a job folder) 30 that stores a document to be distributed. In the configuration example shown in FIG. 3, the job file 30 is specified by a unique job ID. The job file (the job folder) 30 specified by the job ID stores, concerning one document, document data 31, distribution ID data 32, and replacement data 33. The distribution ID data 32 and the replacement data 33 are information set according to designation by the user. Therefore, in the job file 30, the distribution ID data 32 and the replacement data 33 could be omitted.

In the example shown in FIG. 3, the document data 31 includes “Data.PS”, “Document name.txt”, “Thumbnail.png”, and “Page data (pages)”. “Data.PS” is a PDL file of the document data 31. “Document name.txt” is a text file that stores information indicating a name of a document stored in the job file 30. “Thumbnail.png” is a file of an icon indicating a first page of the document. “Page data (pages)” is a folder that stores data obtained by converting pages of a document into predetermined image data. In the “Page data (pages)” folder, the image data of the pages are respectively stored as image files (Page001.JPG and Page002.JPG). In the “Page data (pages)” folder, image data having different resolutions may be stored for various devices used as the user terminal 1. In the “Page data (pages)” folder, the image data of the pages may be dividedly stored.

In the example shown in FIG. 3, the job file 30 stores “Distribution ID.txt” as distribution ID data 32 for a document. “Distribution ID.txt” stores information indicating distribution IDs of document data stored in the job file 30. “Distribution ID.txt” is information set when distribution ID of the document data stored in the job file 30 are designated. For example, “Distribution ID.txt” stores information indicating users set as the distribution ID. Concerning a job file for which distribution ID of document data are not designated, “Distribution ID.txt” is omitted. The information indicating the distribution ID of the document data stored in the job file 30 may be stored in a database such as a job management database explained later.

The job file 30 in which replacement is designated for a document stores the “replacement data” 33. The “replacement data” 33 is information concerning replacement (replacement information) associated with document data of the job file. For example, the “replacement data” 33 includes information indicating replacement source document data (job file), text information indicating replaced content, or image information illustrating a changed portion in a replaced page image. Concerning a job file of document data for which replacement is not designated, “replacement data” is omitted.

In the example shown in FIG. 3, the “replacement data” 33 is stored in a replacement folder. In the example shown in FIG. 3, “Replacement source.txt”, “Replacement comment.txt”, and “replacement image data” are stored in the replacement folder in which the “replacement data” 33 is stored. “Replacement source.txt” is a text file that stores information indicating replacement source document data (job file). “Replacement comment.txt” is a text file that stores a comment (text information) indicating replaced content or the like.

“Replacement image data” is image data indicating a replaced portion (a changed portion). For example, the image data indicating the replaced portion (the changed portion) is created for each replaced page. In the example shown in FIG. 3, “replacement image data” is stored in a “Replaced pages” folder. For example, the image data stored in the “replacement image data” is image data indicating a changed portion (a replaced portion) in a replaced page image. In the example shown in FIG. 3, in the “Replaced pages” folder, image data (CommentPage001.GIF) of a data format (the gif format) that can be displayed to be superimposed on a page image is stored as the image data indicating the changed portion. The image data indicating the changed portion may be vector data. As the image data indicating the changed portion, image data of page images of document data may be prepared for each of different resolutions.

The job management database 24b stores information concerning document data stored in a job file. The job management database 24b stores job IDs of job files and user IDs of users who upload the job files in association with each other. If a meeting ID is set for a job file, the job management database 24b stores a meeting ID set in association with a job ID of the job file. If distribution ID are set for a job file, the job management database 24b stores information indicating distribution ID set in association with a job ID of the job file.

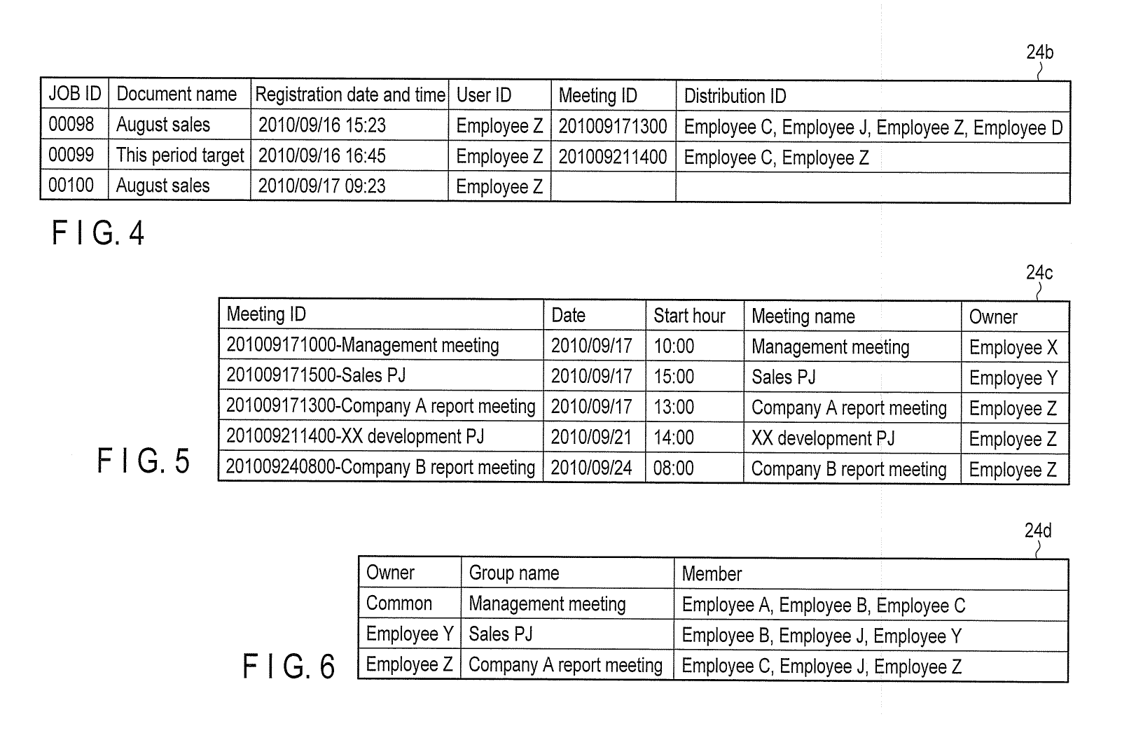

FIG. 4 is a diagram of a configuration example of the job management database 24b. In the configuration example shown in FIG. 4, in the job management database 24b, concerning jobs including documents, pieces of information concerning a job ID, a document name, a registration date and time, a user ID, a meeting ID, and distribution ID are stored in association with one another. With the job management database 24b shown in FIG. 4, it is possible to search for a job according to a user ID and search for a job according to a meeting ID. If setting of a meeting corresponding to a job is absent, in the job management database 24b, the information concerning the meeting ID is blank. If setting of distribution ID corresponding to a job is absent, in the job management database 24b, the information concerning the distribution ID is blank.

The meeting setting database 24c stores information concerning a meeting in which a document registered as a job file is used. FIG. 5 is a diagram of a configuration example of the meeting setting database 24c. In the configuration example shown in FIG. 5, the meeting setting database 24c stores, concerning one meeting, pieces of information concerning a meeting ID, a holding date (a date), a start hour, a meeting name, and an owner in association with one another. A document registered as a job file is associated by the job management database 24b with a meeting (a meeting ID) set by the meeting setting database 24c. Meetings registered in the meeting setting database 24c shown in FIG. 5 are identified with meeting IDs.

The group setting database 24d stores information indicating users included in a group. FIG. 6 is a diagram of a configuration example of the group setting database 24d. In the configuration example shown in FIG. 6, the group setting database 24d stores, concerning the groups, pieces of information concerning an owner, a group name, and members in association with one another. A user can designate, as distribution ID of a document, a group set by the group setting database 24d. If a group is designated as distribution ID of a document, the management server 2 sets users belonging to the group as distribution ID of the document. Since a group is set according to the group setting database 24d, the user can designate distribution ID of a document not only in a unit of an individual user but also in a unit of a group.

Various kinds of processing in the document distribution system are explained.

In the document distribution system, the user terminal 1 performs, for example, upload processing for uploading a document for distribution to the management server 2, processing for designating distribution ID for the uploaded document (input processing for distribution setting), processing for designating replacement of the uploaded document (including the distributed document) (replacement designation processing), processing for displaying the document registered in the management server 2 (viewing processing), and processing for notifying the management server 2 of a viewing state of the document (notification processing for a viewing history).

The management server 2 performs, for example, registration processing for registering, as a job file, the document uploaded from the user terminal 1, distribution setting processing for setting distribution ID and the like for the registered document, replacement setting processing for setting replacement for the registered document, distribution processing for distributing the document to the user terminal 1 according to the distribution setting, and replacement notification processing corresponding to the replacement setting and the viewing history of the document.

In the document distribution system according to this embodiment, the user terminal 1 executes the computer programs (e.g., the printer driver and the Web browser) stored in the HDD 14 or the ROM 13 by the processor 11 to thereby realize the various kinds of processing. The management server 2 executes the computer programs stored in the HDD 24 or the ROM 23 by the processor 21 to thereby realize the various kinds of processing.

The upload processing in which the user terminal 1 uploads a document for distribution to the management server 2 is explained.

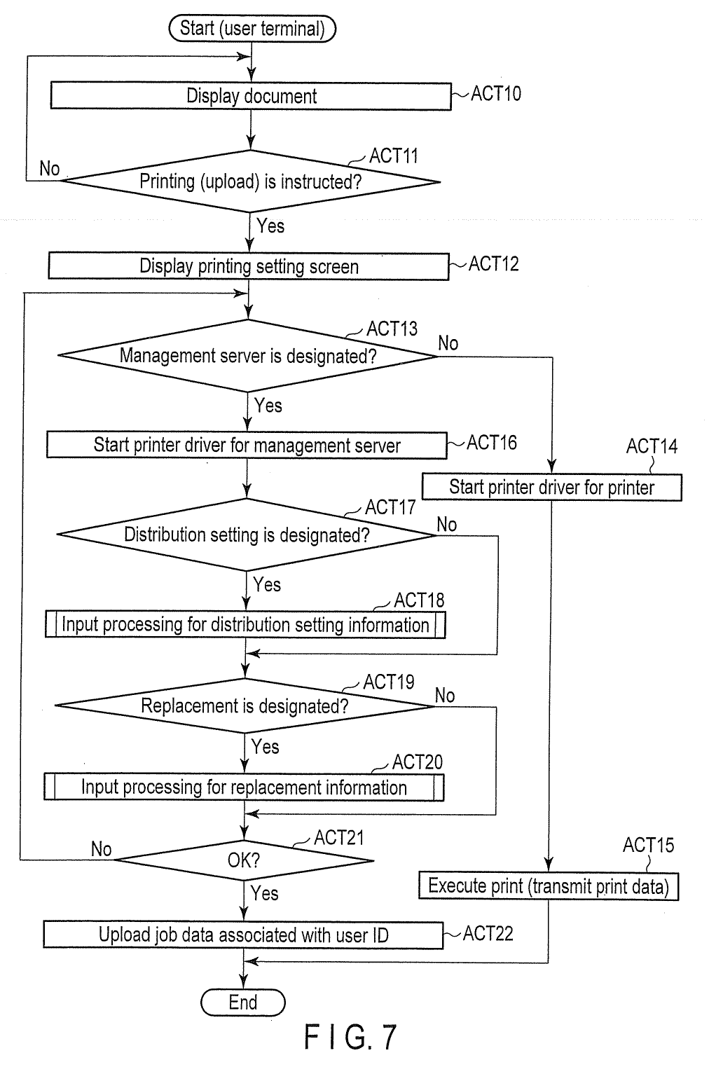

FIG. 7 is a flowchart for explaining an example of the upload processing for uploading a document from the user terminal 1 to the management server 2.

As a function realized by the printer driver executed by the processor 11 in the user terminal 1, processing for uploading a document to be distributed to the other users to the management server 2 is explained. The user terminal 1 is enabled by the printer driver to perform operation for uploading a document to the management server 2 according to an operation procedure similar to an operation procedure for causing a printer to print the document. However, the processing for uploading a document to the management server 2 is not limited to the processing realized as the function of the printer driver. For example, the document may be uploaded to the management server 2 using another application for upload.

In the user terminal 1, the user selects, with the operation section 17, a document to be distributed to the other users. The processor 11 displays the document selected by the user with the operation section 17 on the display section 16 (ACT 10). In a state in which the document to be distributed is displayed (selected), the user inputs, with the operation section 17, an instruction for uploading the document to the management server 2. In this embodiment, as the processing for uploading a document to the management server 2, processing realized by the printer driver is assumed. Therefore, in order to instruct the upload of the document, the user inputs a printing instruction for the document (a display instruction for a printing setting screen).

If the user inputs a printing instruction for the document (upload of the document) (YES in ACT 11), the processor 11 displays a printing setting screen on the display section 16 (ACT 12). On the printing setting screen, the user selects one of the printer and the management server 2 as an apparatus set as a transfer destination of document data. For example, if the user instructs printing of the document, the user selects, on the printing setting screen, the printer that executes printing. If the user instructs upload of the document for distribution, the user selects, on the printing setting screen, the management server 2 that registers (manages) the document for distribution.

If the user selects, on the printing setting screen, the printer for printing the document (NO in ACT 13), the processor 11 starts a printer driver corresponding to the selected printer (ACT 14). After starting the printer driver corresponding to the selected printer, the processor 11 performs print control such as print setting by the printer driver and a print request to the printer (ACT 15).

If the user selects, on the printing setting screen, the management server 2 to which the document for distribution is uploaded (YES in ACT 13), the processor 11 starts a printer driver corresponding to the selected management server 2 (a computer program for performing upload processing for the document) (ACT 16). The printer driver corresponding to the management server 2 is a computer program for performing upload processing for the document. Specifically, if the user selects the management server 2, the processor 11 executes the printer driver corresponding to the management server 2 to thereby perform processing such as upload of the document, designation of distribution ID for the document, and replacement designation for the document (ACTS 17 to 22).

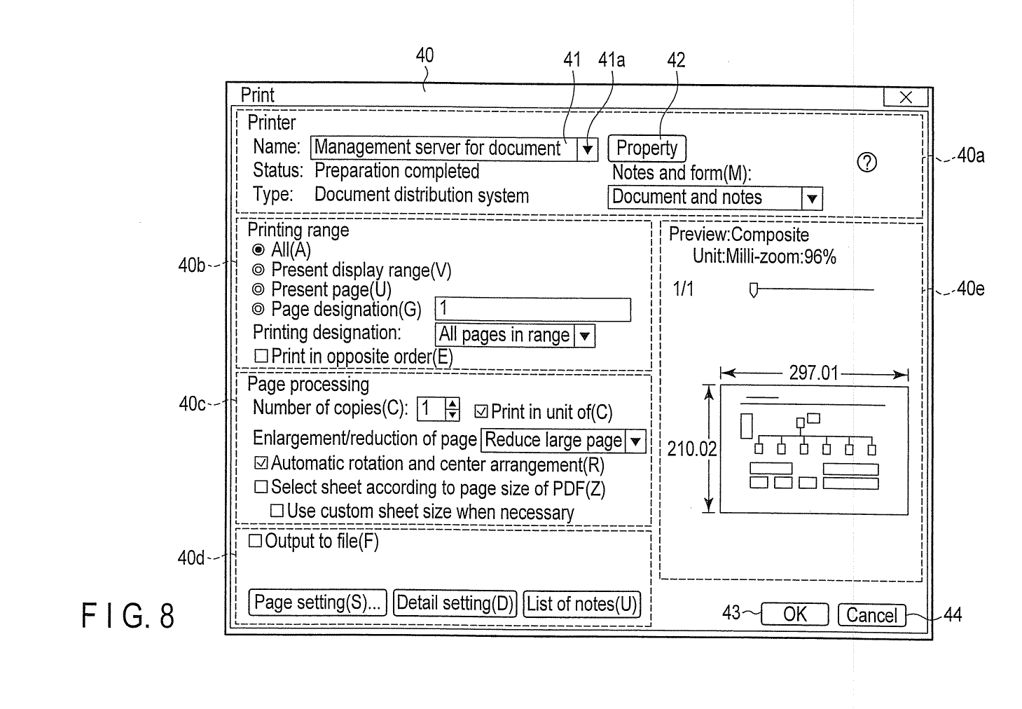

FIG. 8 is a diagram of a display example of a printing setting screen 40 displayed on the display section 16 of the user terminal 1. The printing setting screen 40 shown in FIG. 8 includes a printer setting area 40a, a printing range setting area 40b, a page processing setting area 40c, a file output setting area 40d, a preview screen area 40e, and various buttons (an OK button 43, a cancel button 44, etc.). For example, the display section 16 displays a designation space 41 for a printer and a property button 42 in the printer setting area 40a of the printing setting screen 40. The OK button 43 is a button for instructing execution of processing set on the printing setting screen. The cancel button 44 is a button for instructing cancellation of the processing.

One of the printer that prints a document and the management server 2 to which a document is uploaded is input to the designation space 41. If a button 41a provided adjacent to the designation space 41 is pointed, the display section 16 may display, as a pull-down menu, a list of selectable printers and management servers. In this case, information indicating the printer or the management server 2 selected from the list by the user is input to the designation space 41. The property button 42 is pointed when the user designates, for example, print setting by the designated printer or distribution ID of the document to be uploaded to the designated management server 2.

For example, in printing a document, the user inputs information indicating a printer that executes the print to the designation space 41. If the property button 42 is pointed in a state in which the printer is designated in the designation space 41, the processor 11 receives, with a printer driver corresponding to the designated printer, print setting by the user. If the OK button 43 is pointed in the state in which the printer is designated in the designation space 41, the processor 11 performs print control for printing the document with the designated printer.

In uploading (registering) a document to the management server 2 as a document for distribution, the user inputs information indicating the management server 2, to which the document is uploaded, to the designation space 41. If the property button 42 is pointed in a state in which the management server 2 is designated in the designation space 41, the processor 11 receives, with the printer driver corresponding to the management server 2, distribution setting for the document to be uploaded. For example, distribution ID for the document to be uploaded can be input on a distribution setting screen displayed if the property button 42 is pointed in a state in which the management server 2 is designated. The replacement designation and the like may be able to be designated by pointing a predetermined instruction button (a replacement designation button) on the distribution setting screen.

If the user designates the setting of distribution ID for the document to be uploaded (e.g., if the property button 42 is pointed) (YES in ACT 17), the processor 11 displays the distribution setting screen on the display section 16. The processor 11 receives the input of distribution setting information on the distribution setting screen displayed on the display section 16 (ACT 18). For example, the distribution setting information is information such as a meeting associated with the document and users set as distribution ID of the document. The input distribution setting information is set as, together with document data, data (job data) to be uploaded to the management server 2.

The distribution setting information may be input after the document is uploaded to the management server 2. In other words, the designation of distribution ID may be performed for a document (a job file) already registered in the management server 2. In such a form, the distribution setting information does not always need to be input in the processing for uploading a document to the management server 2.

If the user designates replacement of the document (YES in ACT 19), the processor 11 receives the input of information concerning the replacement of the document and performs input processing for the replacement information (ACT 20). The replacement information is information indicating the replacement source document, a comment indicating replaced content, and information such as image data indicating a correction portion as a figure. These pieces of replacement information are information input by the user. The replacement information may be designated after the document is uploaded to the management server 2. In other words, the replacement information may be set for the document (the job file) registered in the management server 2. In such a form, it is unnecessary to input the replacement information in the processing for uploading the document to the management server 2.

If the OK button 43 is pointed in a state in which the management server 2 is designated in the designation space 41 (YES in ACT 21), the processor 11 uploads job data including the document to the management server 2 (ACT 22).

For example, if the OK button 43 is pointed after distribution setting is input, the processor 11 updates job data including the document data and distribution setting information for the document to the management server 2. If the OK button 43 is pointed after distribution setting and replacement designation are input, the processor 11 uploads job data including the document data and distribution setting information and replacement setting information for the document to the management server 2. If the OK button 43 is pointed without the input of distribution setting information, the processor 11 uploads job data without distribution setting information for the document to the management server 2. If the OK button 43 is pointed without replacement setting, the processor 11 uploads job data without replacement setting information for the document to the management server 2.

An input example of distribution setting information by the printer driver in the user terminal 1 is explained.

As a function provided by the printer driver, the user terminal 1 may input distribution setting information for a document to be uploaded or may input distribution setting information for a document already registered on a Web page provided by the management server 2 with the Web browser. As an input example of the distribution setting information, an example in which, as a function provided by the printer driver, the user terminal 1 inputs distribution setting information for a document to be uploaded is explained.

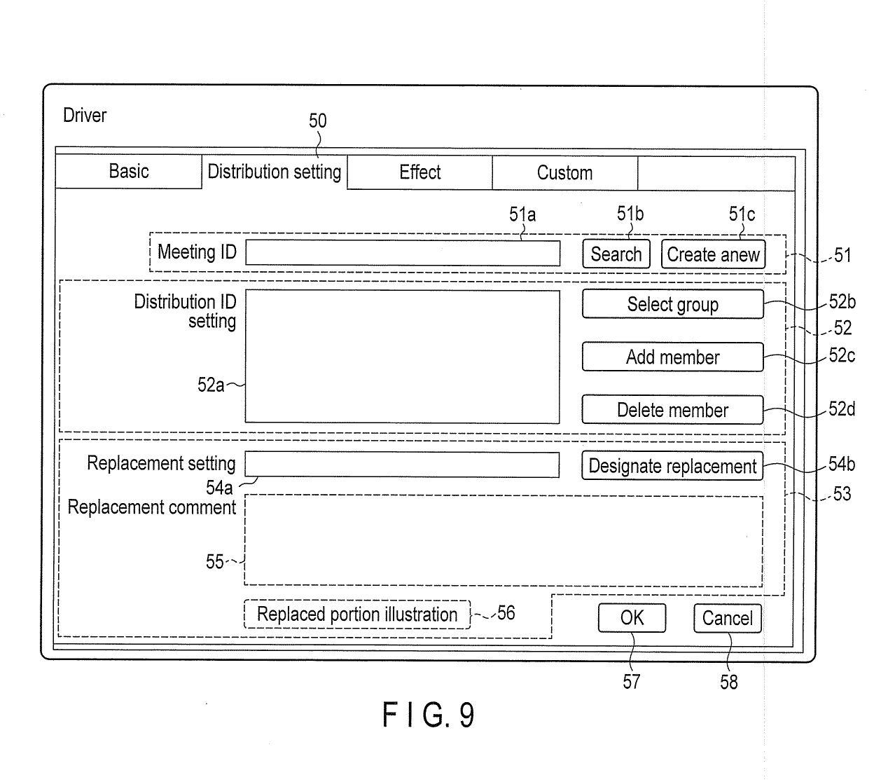

FIG. 9 is a diagram of a display example of a distribution setting screen 50 for a document to be uploaded.

For example, if the property button 42 is pointed in a state in which the management server 2 is designated in the designation space 41 on the printing setting screen 40 shown in FIG. 8, the processor 11 displays the distribution setting screen 50 shown in FIG. 9 on the display section 16. It is assumed that the distribution setting screen 50 shown in FIG. 9 is displayed in a state in which a tab of distribution setting is selected in a setting screen displayed by the printer driver. On the distribution setting screen 50 shown in FIG. 9, the user can input meeting ID setting, distribution ID setting, and replacement setting. Information input as the meeting ID setting and the distribution ID setting is referred to as distribution setting information. Information input as the replacement setting is referred to as replacement information.

The distribution setting screen 50 shown in FIG. 9 includes a meeting setting area 51, a distribution ID setting area 52, and a replacement setting area 53. In the meeting setting area 51, a display space 51a for a meeting ID, a search button 51b, and a new creation button 51c are displayed. In the distribution ID setting area 52, a distribution ID display space 52a, a group selection button 52b, a member addition button 52c, and a member deletion button 52d are displayed. In the replacement setting area 53, a display space 54a for a replacement source, a replacement designation button 54b, a replacement comment space 55, a replaced portion illustration button 56 are displayed. Further, on the distribution setting screen 50, an OK button 57 and a cancel button 58 are also displayed.

In setting a meeting for a document to be uploaded, the user inputs, to the display space 51a on the distribution setting screen 50 shown in FIG. 9, a meeting ID of a meeting associated with the document. The user may select the meeting associated with the document from existing meetings or may create anew the meeting associated with the document.

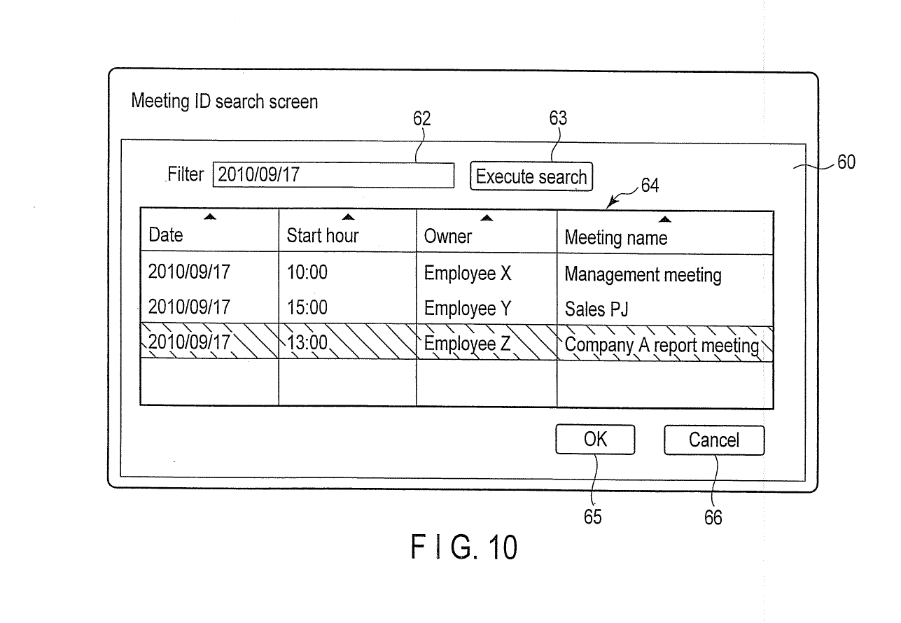

If the user selects, from the existing meetings, the meeting associated with the document to be uploaded, the user points a search button 51b. When the search button 51b is pointed, the processor 11 displays, on the display section 16, a selection screen for selecting a desired meeting from the existing meetings (a meeting ID search screen). FIG. 10 is a diagram of a display example of a meeting ID search screen 60. The meeting ID search screen 60 shown in FIG. 10 includes an input space 61, a search execution button 62, a list 63, an OK button 64, and a cancel button 65.

Information serving as a key for searching for a meeting is input to the input space 61. For example, if a meeting is searched with a date of the meeting, as shown in FIG. 10, a date is input to the input space 61. The search execution button 62 is a button for instructing the user terminal 1 to execute a search for a meeting with the information input to the input space 61. As the list 63, a list of meetings is displayed as a search result. The user can select one meeting from plural meetings displayed in the list 63. The OK button 64 is a button for instructing the end of the selection of a meeting. The cancel button 65 is a button for instructing cancellation of the selection of a meeting. For example, if the OK button 64 is pointed in a state in which a meeting of “company A report meeting” is selected in the list 63 as shown in FIG. 10, the processor 11 displays, on the display section 16, the distribution setting screen 50 on which a meeting ID of the “company A report meeting” in the display space 51a for a meeting ID.

If the user creates a new a meeting associated with a document to be uploaded, the user points the new creation button 51c. When the new creation button 51c is pointed, the processor 11 displays, on the display section 16, an input screen for creating a new meeting. If the user inputs a meeting name or the like in this state, the processor 11 issues a meeting ID for the input new meeting and registers the meeting ID in the meeting setting database 24c. In this case, the processor 11 displays, on the display section 16, the distribution setting screen 50 on which the meeting ID created anew is displayed in the display space 51a.

If distribution ID are set for a document to be uploaded, the user displays user names set as the distribution ID of the document in the display space 52a on the distribution setting screen 50 shown in FIG. 9. The users set as the distribution ID may be designated in a group unit or the respective users may be added or deleted. For example, if the users set as the distribution ID are selected in a group unit, the user points the group selection button 52b. If the individual users are added to the distribution ID, the user points the member addition button 52c. If the individual users are deleted from the distribution ID, the user points the member deletion button 52d.

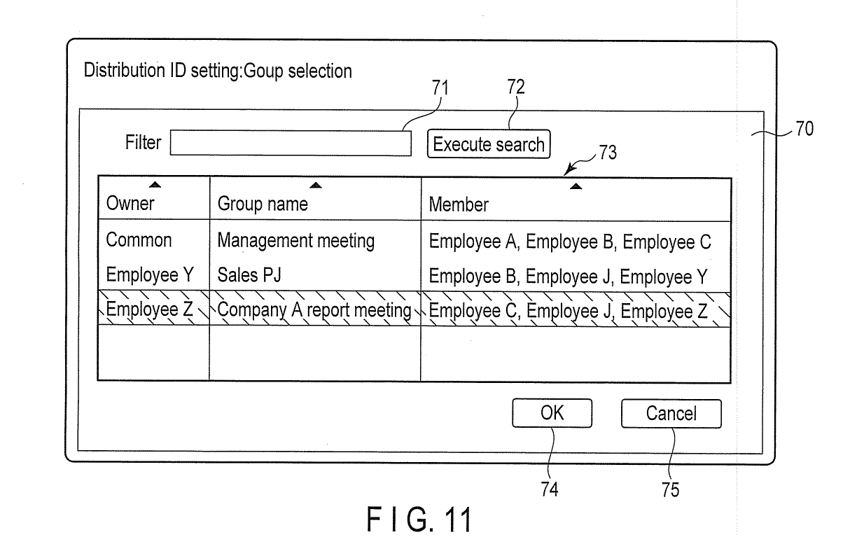

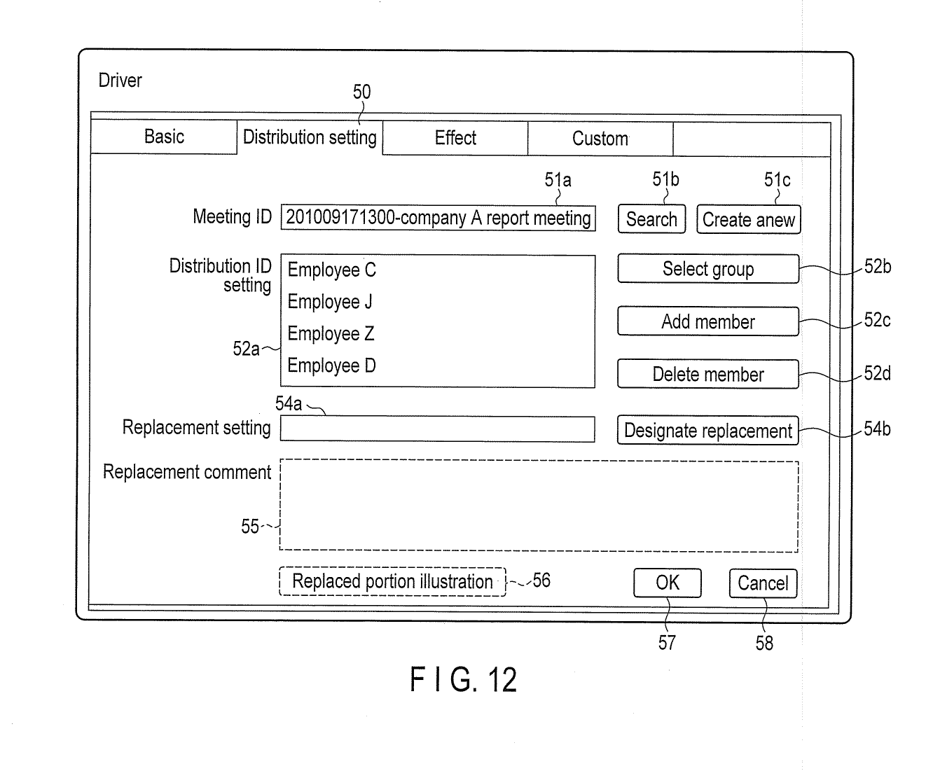

When the group selection button 52b is pointed, the processor 11 displays, on the display section 16, a selection screen for the user to select distribution ID groups from groups (a group selection screen). FIG. 11 is a diagram of a display example of a group selection screen 70. The group selection screen 70 shown in FIG. 11 includes an input space 71, a search execution button 72, a list 73, an OK button 74, and a cancel button 75.

Information serving as a key for searching for a group is input to the input space 71. The search execution button 72 is a button for instructing the user terminal 1 to search for a group with the information input to the input space 71 as a key. As the list 73, a list of groups is displayed as a result of the search. The user can select one or plural groups from plural groups displayed in the list 73. The OK button 74 is a button for instructing the end of the selection of distribution ID groups. The cancel button 75 is a button for instructing cancellation of group selection.

If the user points the search execution button 72 in a state in which the input space 71 is blank, the processor 11 displays, in the list 73, as a search result, all groups registered in the group setting database 24d. As shown in FIG. 11, if the OK button 74 is pointed in a state in which a group of the “company A report meeting” is selected in the list 73, the processor 11 displays, on the display section 16, the distribution setting screen 50 on which all users (an employee C, an employee J, and an employee Z) belonging to the group of the “company A report meeting” are displayed in the distribution ID display space 52a.

FIG. 12 is a diagram of a setting example of distribution setting information (a meeting ID and distribution ID).

In a display example shown in FIG. 12, a meeting having a meeting ID “201009171300-company A report meeting” is set. Employees C, J, Z, and D are set as distribution ID. In the example shown in FIG. 11, the employees C, J, and Z are the members of the company A report meeting. In other words, the distribution ID shown in FIG. 12 are set by, after selecting the “company A report meeting” as a group, pointing the member addition button 52c to separately add the employee D.

If a document already registered in the management server 2 is replaced with a document to be uploaded, the user points the replacement designation button 54b on the distribution setting screen 50 shown in FIG. 9 and inputs information indicating a replacement source document in the display space 54a for a replacement source. If the replacement designation button 54b is pointed, the processor 11 of the user terminal 1 performs processing for causing the user to designate (select) a replacement source document. For example, if the replacement designation button 54b is pointed, the processor 11 of the user terminal 1 acquires a list of registered documents (e.g., a list of documents, an owner of which is the user) from the management server 2 and displays, on the display section 16, a selection screen for selecting a replacement source document from the acquired documents.

If a replacement source document is selected (designated) (if information indicating a replacement source document is displayed in the display space 54a), the processor 11 overwrites and displays a meeting ID, distribution ID, and the like corresponding to the replacement source document as a meeting ID, distribution ID, and the like of the document. For example, on the distribution setting screen 50, the meeting ID corresponding to the replacement source document is overwritten and displayed in the display space 51a and a list of the distribution IDs corresponding to the replacement source document is displayed in the display space 52a.

If a replacement source document is designated (if information indicating a replacement source document is displayed in the display space 54a), the processor 11 enables the input of content (text information) to the replacement comment space 55 and enables selection of the replaced portion illustration button 56. In this state, the user inputs, with the operation section 17, text information indicating replaced content (changed content) to the replacement comment space 55.

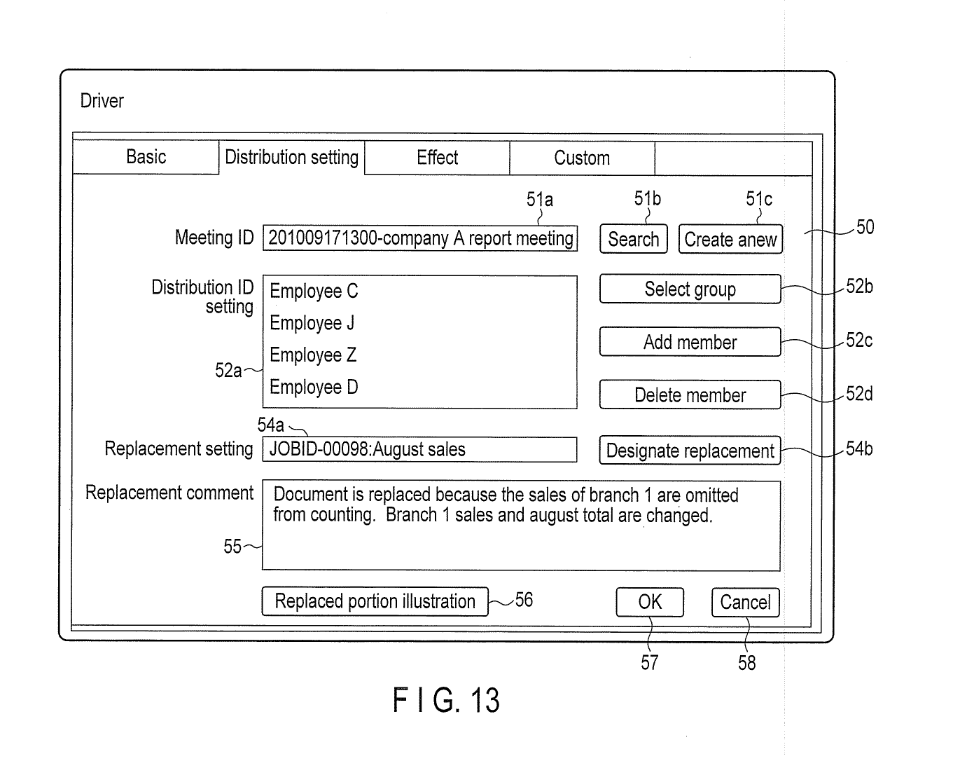

FIG. 13 is a diagram of an example in which the information indicating the replacement source document is displayed in the display space 54a and the input text information is displayed in the replacement comment space 55 on the distribution setting screen 50. In the display state of the distribution setting screen 50 shown in FIG. 13, the replaced portion illustration button 56 is further displayed in a state in which the replaced portion illustration button 56 can be pointed.

If the replaced portion illustration button 56 is selected on the distribution setting screen 50, the processor 11 performs processing for creating image data of an image (an illustration image) indicating a replaced portion (a changed portion). For example, if the replaced portion illustration button 56 is selected, the processor 11 displays a creation screen for inputting a figure or the like indicating a replaced portion on a replacement source page image. The processor 11 creates, according to an instruction of the user on the creation screen, image data of an illustration image indicating a changed portion. The processor 11 uploads the illustration image of the changed portion created according to the instruction of the user to the management server 2 as a predetermined image data format together with data of the document.

The designation of distribution ID and replacement does not have to be an essential condition for uploading a document. In other words, the designation of distribution ID and replacement may be performed after the document is uploaded to the management server 2. For example, the user terminal 1 may upload document data, a meeting ID and distribution ID of which are set by the printer driver, to the management server 2 and apply replacement setting to a document after being uploaded to the management server 2 with the Web browser (a registered document).

Registration processing for a document in the management server 2 is explained.

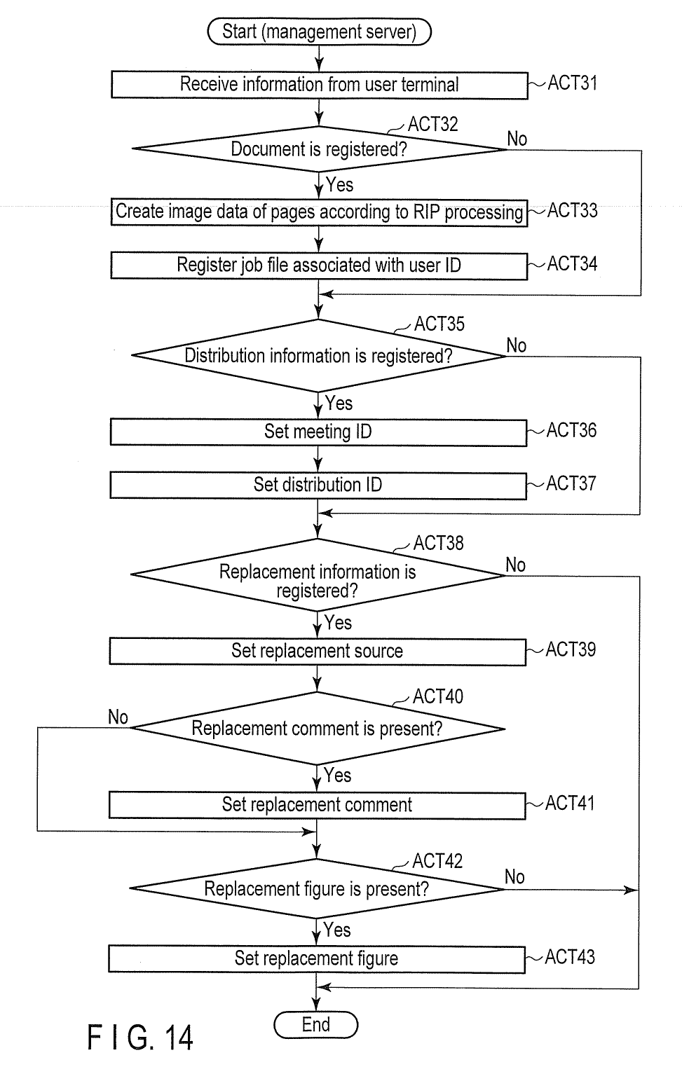

FIG. 14 is a flowchart for explaining a flow of the registration processing for a document in the management server 2.

The management server 2 receives, with the network interface 25, data from the user terminal 1 via the network 5 (ACT 31). The processor 21 determines whether the received data includes document data that should be registered as a job file (ACT 32). If the management server 2 receives job data including document data from the user terminal 1 (YES in ACT 32), the processor 21 converts, with the image processing section 26, pages of the received document data into predetermined image data (ACT 33).

For example, if the document data uploaded from the user terminal 1 is a PDL format, the image processing section 26 converts pages of a document into image data of a predetermined format (e.g., the JPEG format) according to RIP processing. When the image data of the pages are generated by the image processing section 26, the processor 21 stores the received document data and a job file including the image data of the pages in the job storing section 24a in the HDD 24 (ACT 34). Processing for converting the data of the document into image data may be carried out by another server connected to the management server 2.

The processor 21 determines whether distribution setting information indicating distribution ID of the document is included in the received data (ACT 35). For example, the distribution setting information may be received together with the document data or may be received as data associated with a registered document. If distribution setting information of the document is received (YES in ACT 35), the processor 11 sets a meeting ID and distribution ID on the basis of the received distribution setting information (ACTS 36 and 37).

For example, if a job file is managed in the job management database 24b shown in FIG. 4, the processor 11 stores the meeting ID and the distribution ID included in the distribution setting information in association with a job ID of the job file including the document. If the job file is formed in the configuration shown in FIG. 3, as the setting of distribution ID, the processor 11 generates a data file (Distribution ID.txt) indicating the distribution ID on the basis of the distribution setting information and stores the generated data file indicating the distribution ID in the job file of the document.

The processor 21 determines whether replacement information concerning replacement of the document is included in the received data (ACT 38). For example, the replacement information may be received together with the document data to be registered or may be received as setting information associated the registered document. If replacement information concerning replacement of the document is received (YES in ACT 38), the processor 11 sets replacement data such as a replacement source document, a replacement comment, and a replacement figure on the basis of the received replacement information (ACTS 39 to 43).

For example, if the job file is formed in the configuration shown in FIG. 3, as replacement setting for the document of the job file, the processor 11 sets replacement data such as a file indicating a replacement source document (Replacement source.txt), a text file of replacement comment (Replacement comment.txt), and an image file (the gif format) of an illustration image of a changed portion.

First, the processor 11 specifies a replacement source document on the basis of the replacement information. When the replacement source document is specified, the processor 11 creates a text file (Replacement source.txt) that stores information indicating the replacement source document (e.g., a job ID of a job file including the replacement source document). When the text file indicating the replacement source document is created, the processor 11 stores the created text file in a replacement data folder in the job file (a job holder) (ACT 39).

If a replacement comment is included in the replacement information (YES in ACT 40), the processor 11 creates a text file (Replacement comment.txt) indicating the replacement comment included in the replacement information. The processor 11 stores the created text file indicating the replacement comment in the replacement data folder in the job file (the job folder) (ACT 41).

If an illustration image of a changed portion is included in the replacement information (YES in ACT 42), the processor 11 creates image data serving as the illustration image of the changed portion included in the replacement information. The illustration image (a replacement figure) of the changed portion only has to be image data illustrating a portion changed by replacement. For example, the image data serving as the illustration image of the changed portion is displayed to be superimposed on an image of a target page in the replacement source document data. As the image data displayed to be superimposed on the replacement source page image, for example, image data of the GIF format may be used. The processor 11 stores the created image data serving as the illustration image of the changed portion in the replacement data folder in the job file (folder) (ACT 43).

According to the processing explained above, the management server 2 can store the replacement information together with distribution ID information associated with document data to be distributed. The management server 2 stores, as replacement information associated with document data of an updated version, for example, information indicating the replacement source document data (the document data of an old version), data of the replacement comment indicating replaced content and the like, and data of the illustration image of the changed portion illustrating the changed portion and the like in the memory. Consequently, concerning the document data of the updated version, it is possible not only to simply distribute the document data of the updated version but also to clearly indicate, for example, which document data the document data of the updated version replaces, what kind of changed content the document of the updated version has, or which portion is changed.

Another method for performing replacement designation for a document from the user terminal 1 is explained.

The display example by the printer driver in which a meeting ID, distribution ID, and a replacement source can be designated by the printer driver is explained above. However, designation of replacement destinations and replacement of a document may be able to be performed on the Web. An example in which the user terminal 1 designates, with the Web browser, distribution ID information and replacement information for a document (a job) already registered in the management server 2 is explained below.

First, the processor 11 of the user terminal 1 starts the Web browser. The processor 11 of the user terminal 1 accesses, with the Web browser, the management server 2 of the document distribution system according to operation by the user. The management server 2 provides a login screen for the document distribution system in response to an access from the user terminal 1. The processor 11 of the user terminal 1 displays, with the Web browser, the login screen for the document distribution system on the display section 16. The user inputs, with the operation section 17, authentication information (a user ID, a password, etc.) to the login screen displayed by the display section 16.

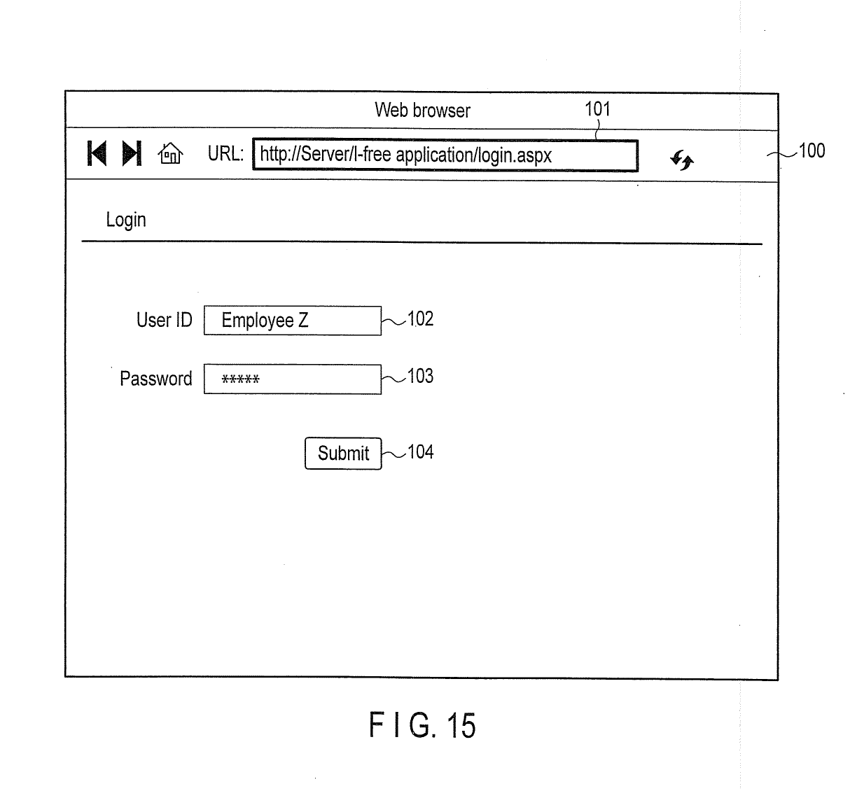

FIG. 15 is a diagram of a display example of the login screen displayed by the Web browser. A login screen 100 shown in FIG. 15 includes an input space 102 for a user ID, an input space 103 for a password, and a Submit button 104 in addition to a display space 101 for a URL. The user operates the operation section 17 or the like to input a user ID to the input space 102 displayed on the display section 16 and input a password to the input space 103 and then points the Submit button 104. When the Submit button 104 is pointed, the processor 11 of the user terminal 1 transmits the input user ID and the input password to the management server 2 together with a request for user authentication.

If a form of performing designation of distribution ID and replacement of a document on the Web is adopted, the management server 2 securely stores in advance authentication information (user IDs, passwords, etc.) of the users who use the document distribution system in the memory such as the HDD 24. The management server 2 acquires authentication information input by the user terminal 1 on a Web page (the login screen). When the processor 21 of the management server 2 acquires the authentication information, the processor 21 performs user authentication using the authentication information acquired from the user terminal 1. If the user authentication is successful, the processor 21 of the management server 2 provides the user terminal 1 with an input screen for inputting distribution ID information or replacement information.

If the user authentication is successful, the processor 21 of the management server 2 provides the user terminal 1 of a job selection screen for selecting a document (a job) to be set for the user terminal 1. The processor 11 of the user terminal 1 displays the job selection screen on the display section 16 with the Web browser. The user selects, with the operation section 17, a document (a job) for which distribution ID or replacement is designated on the job selection screen displayed on the display section 16.

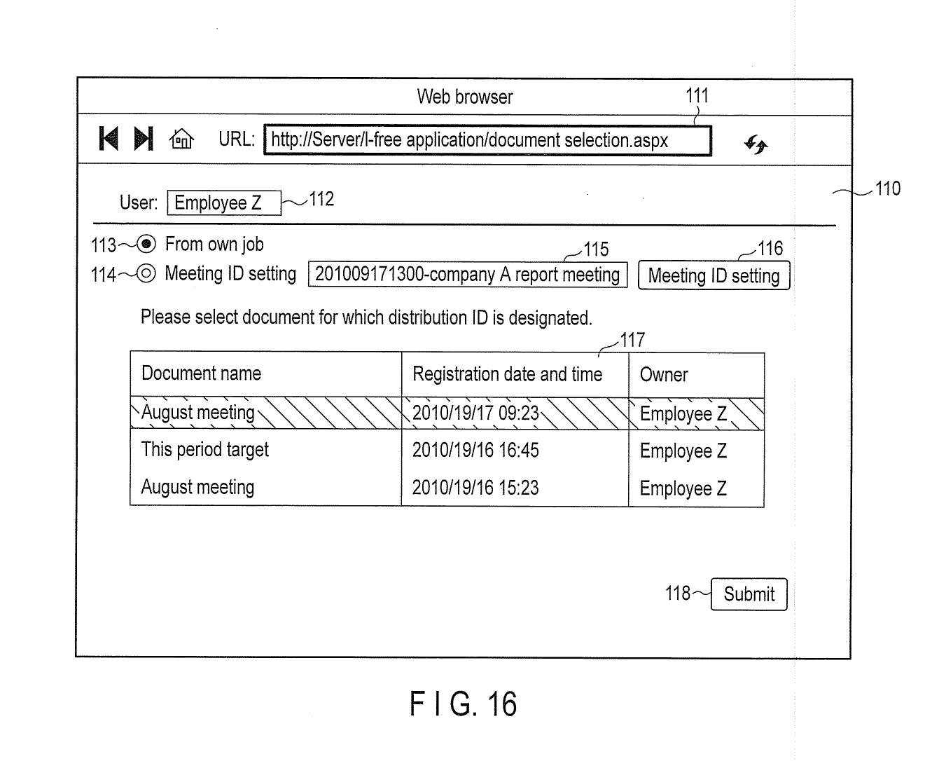

FIG. 16 is a diagram of an example of the job selection screen displayed by the Web browser. On the job selection screen shown in FIG. 16, a list of documents (jobs) that can be selected as a target of designation of distribution ID or replacement is displayed. The job selection screen shown in FIG. 16 includes a display space 111 for a URL, a display space 112 for a user, a selection button 113 for limiting a selectable document to an own job of the user, a selection button 114 for selecting a selectable document according to a meeting ID, a table 117 in which a list of selectable documents is displayed, and a Submit button 118 for instructing selection.

In the table 117 of the job selection screen shown in FIG. 16, a list of documents for which distribution ID or replacement can be designated among documents already registered in the management server 2 is displayed. It is assumed that the user terminal 1 registers in advance, with the printer driver or the like, the documents displayed in the table 117. If the selection button 113 for an own job of the user is pointed on the job selection screen, in the table 117, a list of documents (jobs) registered by the user is displayed. If the selection button 114 for designating a meeting ID is pointed on the job selection screen, in the table 117, a list of documents (jobs) corresponding to a pointed meeting ID is displayed.

If the selection button 113 for an own job of the user is selected on the job selection screen, the processor 21 of the management server 2 searches for documents, an owner of which is a logged-in user (in the example shown in FIG. 16, the employee Z) from the registered documents. The processor 21 of the management server 2 displays, on the basis of a search result, a list of documents of the logged-in user in the table 117.

If the selection button 114 for designating a meeting ID is selected on the job selection screen, the processor 21 of the management server 2 searches for a document corresponding to a designated meeting ID from the registered documents. When the selection button 114 is pointed, the processor 21 displays a meeting selection screen (e.g., a figure). The user selects a meeting ID on the meeting selection screen. When the meeting ID is selected by the user, the processor 21 displays the selected meeting ID in the display space 115. When the meeting ID is input to the display space 115, the processor 21 of the management server 2 displays, in the table 117, a list of documents corresponding to the meeting ID input to the display space 115.

For example, in the display example shown in FIG. 16, the selection button 113 for limiting documents to be displayed in the table 117 to own jobs (of the employee Z) is selected. In other words, documents displayed as a list in the table 117 of the display example shown in FIG. 16 are documents of the logged-in user (the employee Z). In the display example shown in FIG. 16, a document “August sales” displayed at the top of the list of the documents displayed in the table 117 is selected.

If a document for which distribution ID or replacement is designated is selected, the processor 21 of the management server 2 provides the user terminal 1 with a distribution designation screen for designating distribution ID and replacement for the selected document (job). The processor 11 of the user terminal 1 displays, with the Web browser, the distribution designation screen on the display section 16. The user designates, on the distribution designation screen displayed on the display section 16, distribution ID or replacement for the document (the job).

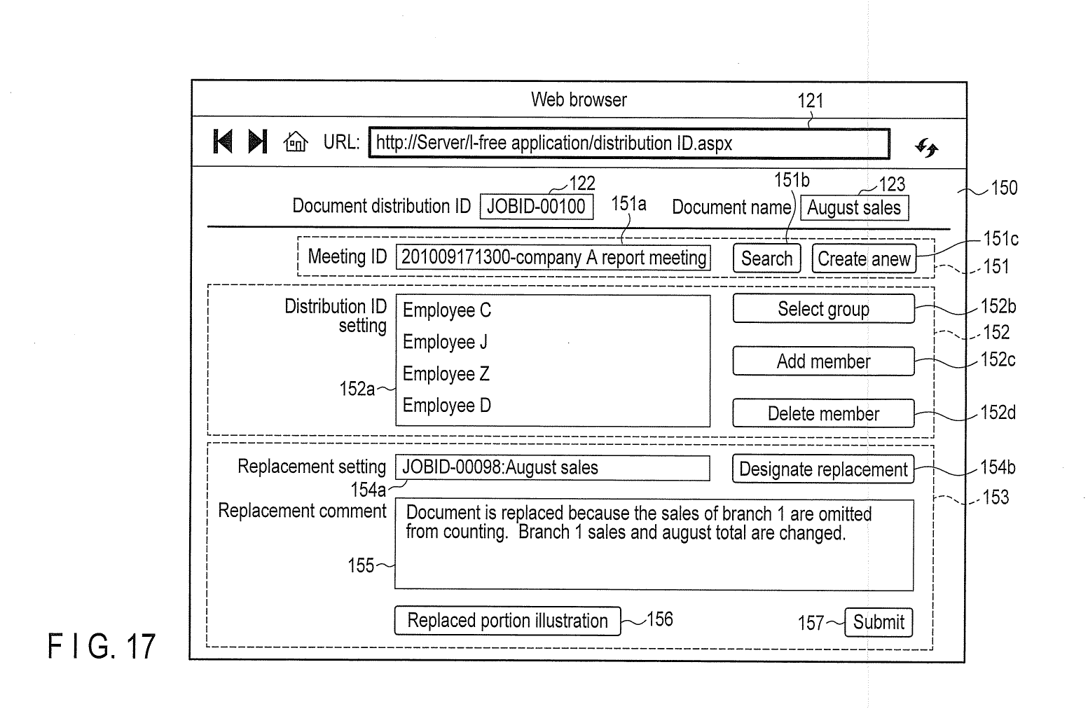

FIG. 17 is a diagram of a display example of the distribution designation screen displayed on the Web page by the Web browser. The distribution designation screen shown in FIG. 17 is a screen for the user to designate distribution ID or replacement for a selected document (job). The distribution designation screen shown in FIG. 17 includes a configuration same as the configuration of the distribution setting screen (a distribution setting screen of a detail setting screen by the printer driver) 50 shown in FIGS. 9, 12, and 13 except that a display space 121 for a URL of the Web browser, a display space 122 for a job ID of a selected document (job), and a display space 123 for a document name are displayed in an upper part of the display screen. In a distribution designation screen 150 shown in FIG. 17, distribution ID and a meeting ID can be designated according to an operation procedure same as the operation procedure for the distribution setting screen shown in FIGS. 9, 12, and 13.

As the replacement information, a replacement source, a replacement comment, and a replacement figure can be designated. On the distribution designation screen 150 shown in FIG. 17, a display space 154a for a replacement source shows a replacement source document (a document of an old version). A replacement designation button 154b is a button pointed when the replacement source document is selected. If the replacement designation button 154b is pointed, the display section 16 displays a selection screen for selecting the replacement source document. As the selection of the replacement source document, one document only has to be selected out of registered documents. For example, the replacement source document may be selected on the selection screen shown in FIG. 16. The replacement comment is test information indicated in replaced content or the like. The user may directly input the replacement comment to an input space 155 using the operation section 17.

A replaced portion illustration button 156 is a button pointed when a replaced portion (a changed portion) or the like is illustrated. If the replaced portion illustration button 156 is pointed, the display section 16 displays an image creation screen for creating an illustration image (a replacement figure) of the changed portion. On the creation screen for an illustration image of the changed portion, the user points, for example, in a page image of a document of the latest version, the changed portion, a figure displayed in the changed portion, and the like using a mouse, a touch panel, or the like. The processor 21 of the management server 2 creates image data of the illustration image including the figure indicating the changed portion according to operation by the user.

The illustration image (the illustration image of the changed portion) is an image in which a figure indicating the changed portion is displayed on the page image of the document. For example, the illustration image is image data displayed to be superimposed on an image of a page in which replacement is performed. The management server 2 stores the image data of the illustration image separately from image data of the document. For example, if the document is managed (registered) in the job file including the configuration shown in FIG. 3, the management server 2 stores, in the job file (the job folder) of the document, an image of the document as image data for each page (Page001.JPG) and stores an illustration image as image data (CommentPage001.gif) of a format that can be displayed to be superimposed on the page image.

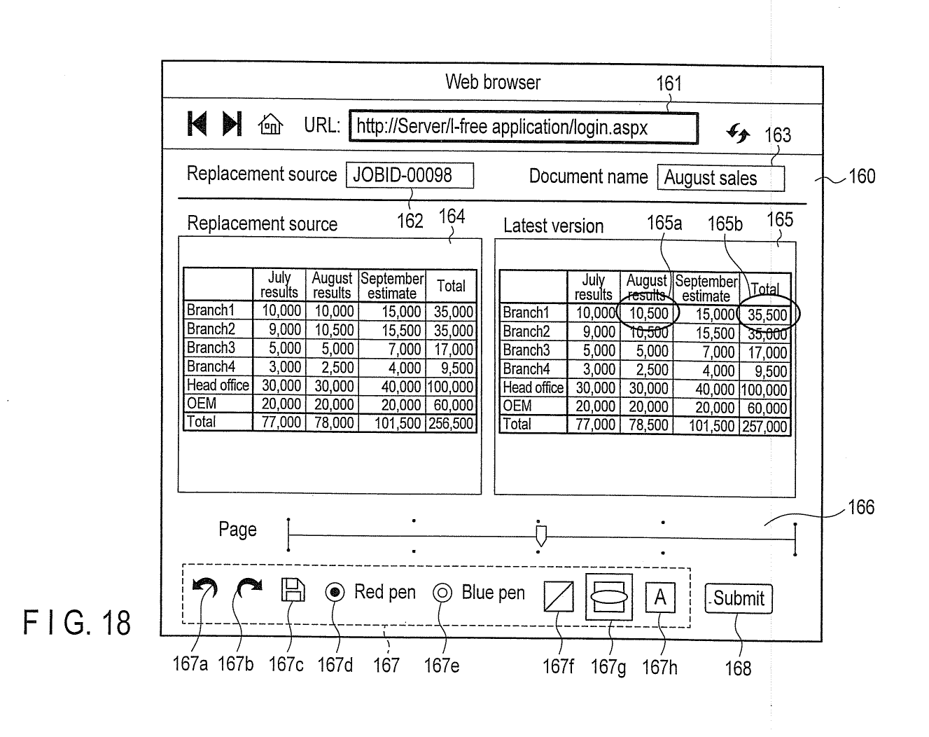

FIG. 18 is a diagram of a display example of an image creation screen 160 for creating an illustration image indicating a changed portion in an updated image.

The image creation screen 160 shown in FIG. 18 includes a display space 161 for a URL, a display space 162 for a replacement source, a display space 163 for a document name, a display space 164 for a replacement source page image, a display space 165 for a page image of the latest version (the document), a slide bar 166, an icon group 167, and a Submit button 168.

In the display example of the image creation screen shown in FIG. 18, the display space 164 and the display space 165 are arranged side by side. This makes it easy to compare a replacement source page image displayed in the display space 164 and a page image of the latest version displayed in the display space 165. The image creation screen 160 includes a slide bar 166 for designating a page to be edited (a changed page). Pages of images displayed in the display spaces 164 and 165 can be changed according to the movement of the slide bar 166. The page to be edited (the changed page) may be designated by directly inputting a page number.

The icon group 167 is an icon group for creating an image. The icon group 167 includes icons (a red pen icon 167d and blue pen icon 167e) for selecting colors of pens for illustrating a changed portion and icons (a straight line icon 167f, an ellipse icon 167g, and a text icon 167h) for designating predetermined figures (a straight line, an ellipse, and a text). The icon group 167 also includes an Undo icon 167a indicating resetting of operation content, a Redo icon 167b indicating redoing of operation, and a saving icon 167c indicating saving.

In the display example shown in FIG. 18, an ellipse 165a and an ellipse 165b are displayed in a space of August results and a space of a total in a column of “branch 1”. For example, an ellipse is displayed by pointing, in a state in which the ellipse icon 167g is selected, a portion desired to be displayed. In other words, in the display example shown in FIG. 17, in a state in which the ellipse icon 167g is selected, the user points the space of August result and the space of a total in the column of “branch 1” of the display space 164 shown in FIG. 17. Then, in the display space shown in FIG. 17, the ellipse 165a is displayed in the space of August result and the ellipse 165b is displayed in the space of a total.

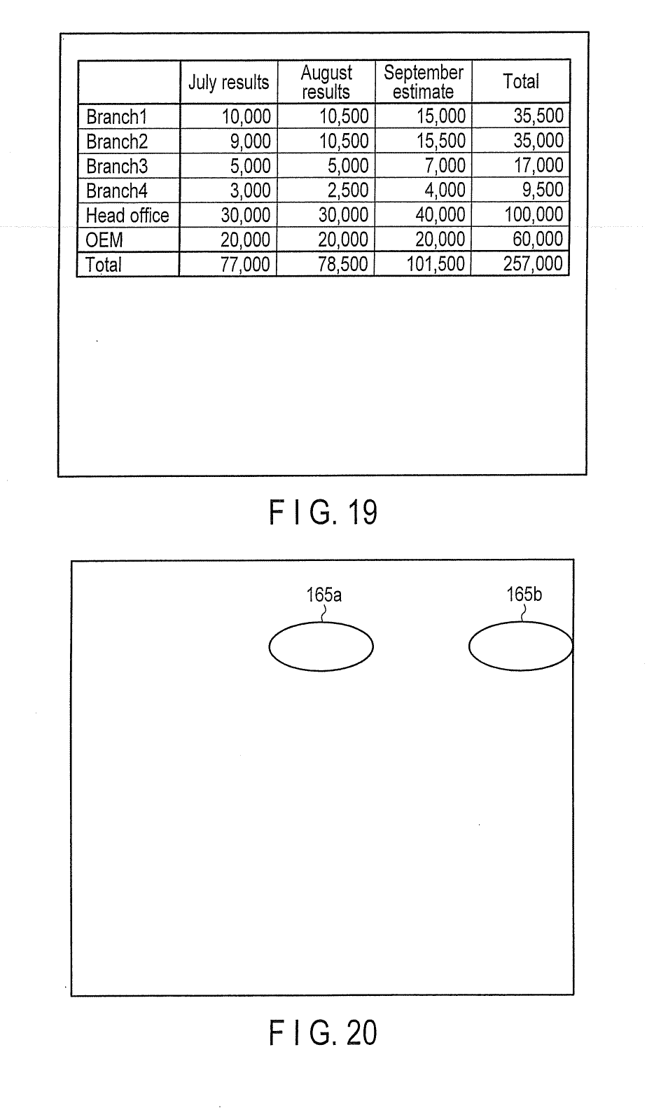

If the user points the Submit button 168 in the display state shown in FIG. 18, the processor 21 of the management server 2 creates image data serving as an illustration image including the figures displayed in the display space 165. In the system according to this embodiment, the management server 2 creates, separately from a page image serving as a document image, image data including a figure indicating a changed portion as an illustration image (an illustration image of the changed portion) displayed to be superimposed on the page image. FIG. 19 is a diagram of an example of the page image including the changed portion corresponding to the display example shown in FIG. 18. FIG. 20 is a diagram of an example of the illustration image of the changed portion displayed to be superimposed on the page image shown in FIG. 19. The illustration image shown in FIG. 20 only has to be displayed to be superimposed on the page image. For example, an image data format such as gif is used.

Viewing and management of document data (a job file) registered by the management server 2 is explained.

Each of the management servers 2 stores, in the history database 24e, viewing situations in distribution ID of a document registered as a job file. The history database 24e stores, concerning distribution IDs of documents, information indicating whether the documents are already downloaded, already viewed (opened), or not downloaded yet.

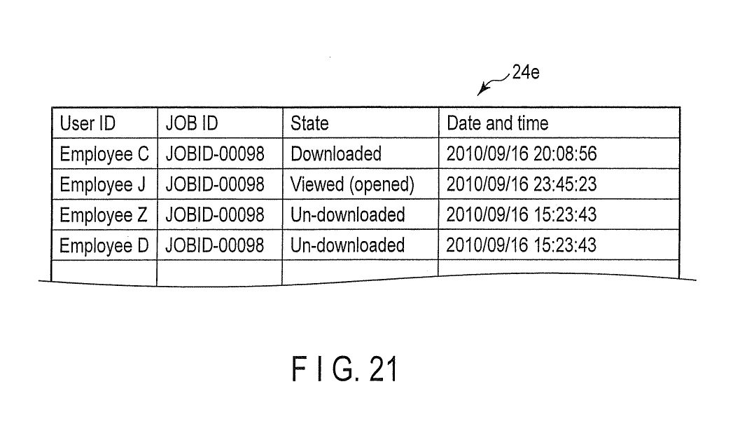

FIG. 21 is a diagram of a configuration example of the history database 24e. In the configuration example shown in FIG. 21, the history database 24e stores, as viewing history information for the distribution IDs of the documents, a user ID serving as information indicating a distribution ID, a job ID serving as information indicating document data, and state information indicating a viewing situation of a document. In other words, the history database 24e is a database that stores viewing history information indicating viewing situations in the distribution IDs of the documents.

For example, it is assumed that document data having a document name “August sales” is registered at 15:23 on Sep. 16, 2010. It is assumed that this document data is registered as a job file having a job ID “JOBID_{—}00098” and the employees C, J, Z, and D are set as distribution ID. In the example shown in FIG. 21, in the history database 24e, four pieces of viewing history information for the four distribution ID of the document data having the job ID “JOBID_{—}00098” are stored.

The viewing history information shown in FIG. 21 indicates that the employee C is in a state in which the document data having the job ID “JOBID_{—}00098” is already downloaded (already downloaded and not viewed yet), the employee J is in a state in which the document data having the job ID “JOBID_{—}00098” is already viewed (opened) (already downloaded and already viewed), and the employees Z and D are in a state in which the document data having the job ID “JOBID_{—}00098” is not downloaded yet (not downloaded yet and not viewed yet).

In the history database 24e, state information is updated according to situations of download of a document to the users and viewing of the document. For example, if a distribution ID is changed (added), the history database 24e is also updated. In the history database 24e shown in FIG. 21, a form in which the user terminal 1 downloads and views document data is assumed. On the other hand, the document data may be displayed by the Web browser. In this case, the history database 24e only has to store, as the state information, information indicating whether the document data is already viewed or not viewed yet.

The user terminal 1 includes the user history database 14a that stores information concerning a download situation and a viewing situation (viewing history information) for document data, a download notification of which is received from the management server 2. The user history database 14a stores viewing history information for documents to be distributed to the user of the user terminal 1. In the user history database 14a, state information of the viewing history information is not limited to “un-downloaded”, “downloaded”, and “viewed (opened)” and could be “updated (replaced)”.

For example, the processor 11 of the user terminal 1 adds, every time the processor 11 receives a download notification concerning document data from the management server 2, viewing history information for the document data to the user history database 14a. In the user history database 14a, the processor 11 of the user terminal 1 sets state information of viewing history information for document data for which download is completed as “downloaded”, sets state information of viewing history information for displayed document data as “viewed (opened)”, and sets state information of viewing history information for document data for which “replaced” is notified as “updated”.

In operation explanation below, a form of managing, with a history database of the management server 2, viewing history information of users for documents is assumed.

A download notification to the user terminal 1 by the management server 2 is explained.

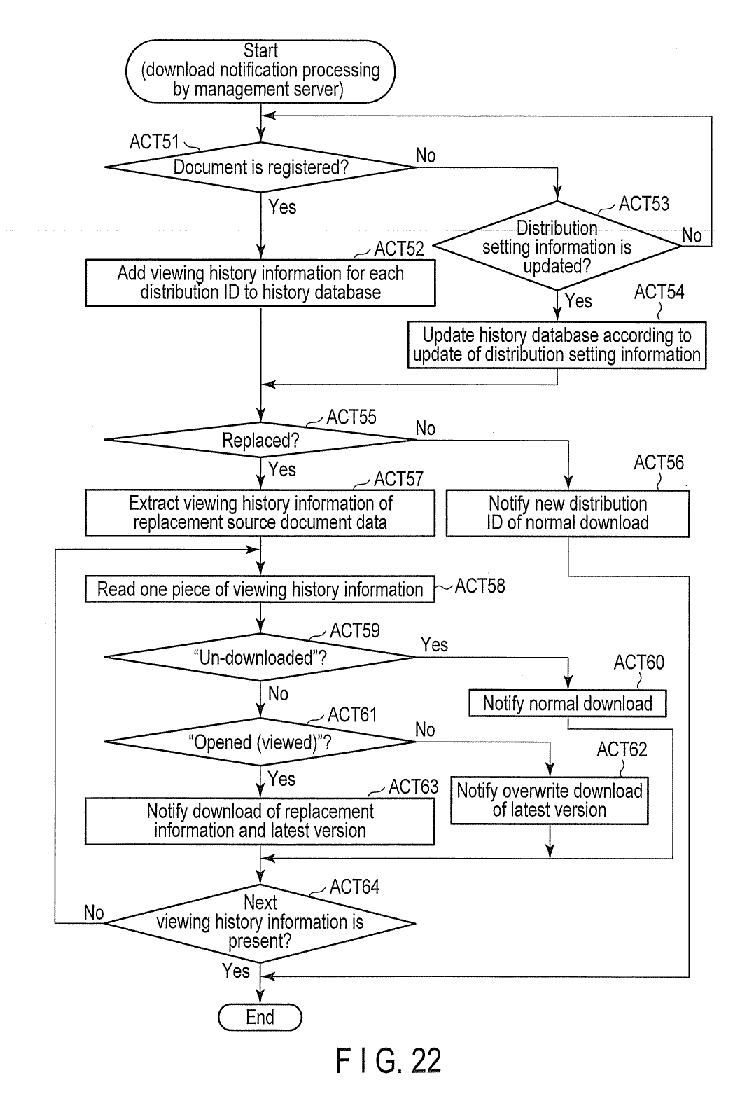

FIG. 22 is a flowchart for explaining a flow of download notification processing by the management server 2.

The processor 21 of the management server 2 determines on the basis of a registration situation of a job file in the job storing section 24a or an update situation of the job management database 24b whether document data is registered anew (ACT 51). If the processor 21 determines that document data is registered (YES in ACT 51), the processor 21 adds a storage area for storing viewing history information for the document data registered anew to the history database 24e (ACT 52).

The processor 21 determines on the basis of an update situation of a job file in the job storing section 24a or an update situation of the job management database 24b whether distribution setting information for registered document data is updated (ACT 53). If the processor 21 determines that the distribution setting information for the document data is updated (YES in ACT 53), the processor 21 updates the history database 24e according to update content of the distribution setting information (ACT 54). For example, when a distribution ID is added, the processor 21 adds a storage area for storing viewing history information corresponding to the added distribution ID to the history database 24e.

If a document is registered anew or distribution setting information is updated, the processor 21 determines whether replacement for the document registered anew is designated or replacement of the document, the distribution setting information of which is updated, is designated anew (ACT 55). If the processor 21 determines that replacement is not designated anew (NO in ACT 55), the processor 21 notifies a new distribution ID of normal download (ACT 56).

If the processor 21 determines that replacement is designated anew (YES in ACT 55), the processor 21 extracts all pieces of viewing history information of distribution ID for replacement source document data from the history database 24e (ACT 57). When the viewing history information is extracted, the processor 21 reads one piece of viewing history information (for one distribution ID) (ACT 58). The processor 21 determines whether state information in the read viewing history information is “un-downloaded” (ACT 59).

If the processor 21 determines that the state information in the read viewing history information is “un-downloaded” (NO in ACT 59), the processor 21 notifies the distribution ID of the viewing history information of normal download (ACT 60). However, if a download notification to the replacement source document is already executed, the processor 21 may not perform a download notification to the distribution ID or may perform a download notification to the distribution ID on another occasion.

If the processor 21 determines that the state information in the read viewing history information is not “un-downloaded” (NO in ACT 59), the processor 21 determines whether the state information of the read viewing history information is “opened” (ACT 61). It is assumed that the state information is any one of “un-downloaded”, “downloaded”, and “opened”. Therefore, determining in ACT 61 that the state information is not opened yet means determining that the state information is “downloaded” (“downloaded” and “unopened”).

If the state information of the read viewing history information is “downloaded” (“downloaded” and “unopened”) (NO in ACT 61), the processor 11 notifies the distribution ID of the viewing history information that a document data of the latest version is downloaded to overwrite the replacement source document data (ACT 62).

If the processor 11 determines that the state information of the read viewing history information is “opened” (YES in ACT 61), the processor 11 notifies the distribution ID of the viewing history information that document data of the latest version and replacement information set for the document data are downloaded (ACT 63).

After performing notification processing corresponding to the state information in ACT 60, ACT 62, and ACT 63, the processor 21 checks whether the next viewing history information (viewing history information for the other distribution ID) not subjected to the notification processing is present in the viewing history information extracted in ACT 57. If the next viewing history information is present, the processor 21 performs the processing from ACT 58 on the basis of the next viewing history information.

With the processing explained above, the management server urges the distribution IDs (the user terminals) that already view the replacement source document to download the document data of the latest version and the replacement information. The management server urges the distribution IDs (the user terminals) that already download and do not view the replacement source document yet to download the document data of the latest version to overwrite the replacement source document data (old document data). With the processing, the management server can notify the distribution ID of appropriate download corresponding to viewing situations concerning a document for which replacement is designated.

Download processing to the user terminal 1 by the management server 2 is explained.

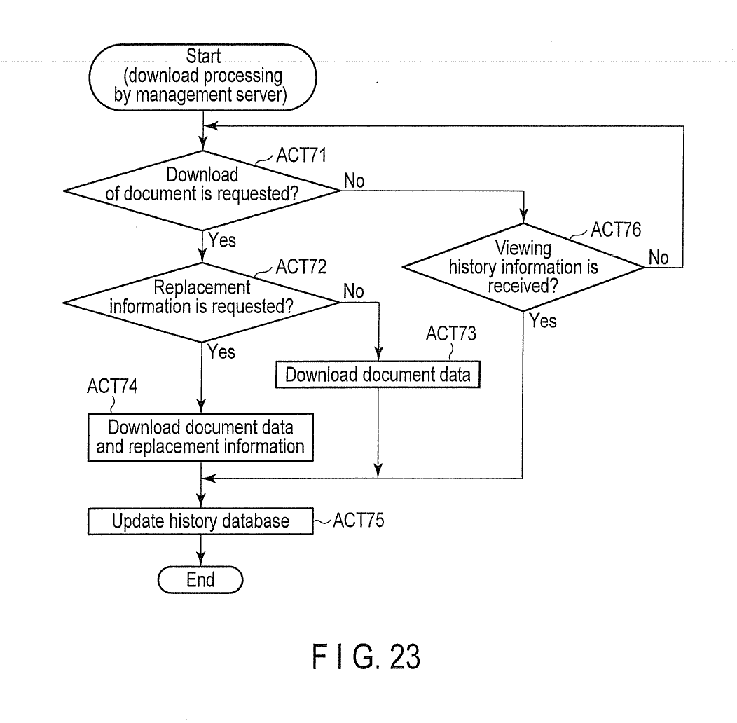

FIG. 23 is a flowchart for explaining a flow of the download processing to the user terminal 1 by the management server 2.

The processor 21 of the management server 2 downloads document data in response to a request from the user terminal 1. For example, if the processor 21 receives a download request for document data from the user terminal 1 (YES in ACT 71), the processor 21 determines whether transfer of replacement information is also requested from the user terminal 1 (ACT 72). If transfer of replacement information is not requested (NO in ACT 72), the processor 21 downloads the designated document data to the user terminal 1 that requests the document data (ACT 73).

If transfer of replacement information together with the document data is requested (YES in ACT 72), the processor 21 downloads, together with the designated document data, replacement data stored in a job file of the document data to the user terminal 1 that requests the download (ACT 74).

When the download to the user terminal 1 is completed, the processor 21 updates, in the history database 24e, state information of viewing history information for the user (the user ID) of the user terminal 1 to “downloaded” concerning the downloaded document data (ACT 75).

The processor 21 of the management server 2 acquires as appropriate not only the download request from the user terminal 1 but also information indicating “viewed (opened)” for the downloaded document data in the user terminal 1. In other words, the user terminal 1 is adapted to notify, if the user views (opens) downloaded document data, the management server 2 that the document data is already opened. If the processor 21 of the management server 2 receives information indicating “viewed (opened)” of the document data from the user terminal 1 (YES in ACT 76), the processing 21 updates the state information in the viewing history information of the document data, a distribution ID of which is the user (the user ID) of the user terminal 1, to “viewed (opened)” (ACT 75).

Download processing for document data from the management server 2 by the user terminal 1 is explained.

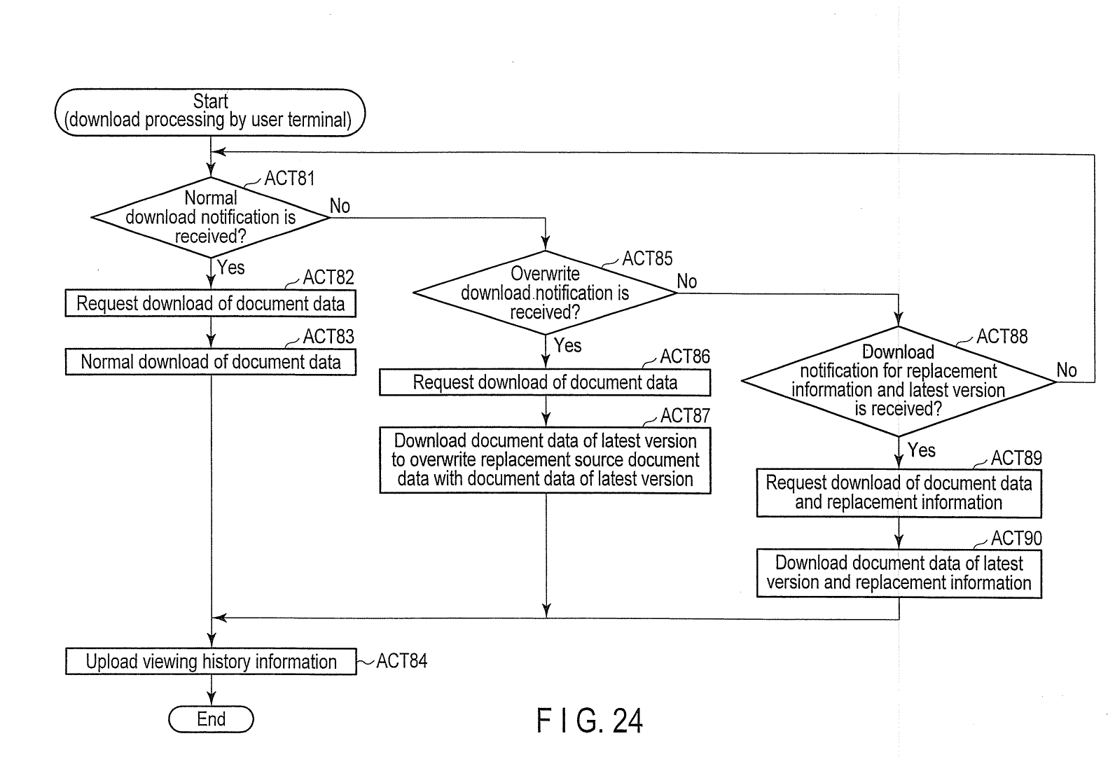

FIG. 24 is a flowchart for explaining a flow of the download processing for document data from the management server 2 by the user terminal 1.

The processor 11 of the user terminal 1 downloads document data according to a download notification from the management server 2. In this system, the management server 2 notifies, concerning document data in which replacement is performed, the user terminals 1 of a download method (download guidance) corresponding to a viewing situation (download and viewing) of the replacement source document data. Therefore, the processor 11 of the user terminal 1 performs download of the document data according to content (the download guidance) notified from the management server 2.

If the processor 11 of the user terminal 1 receives a normal download notification concerning certain document data (YES in ACT 81), the processor 11 requests the management server 2 to download the document data (ACT 82). In this case, the processor 11 stores the document data downloaded from the management server 2 in the HDD 14 as a document distributed anew (ACT 83). When the download of the document data is completed, the processor 11 uploads information indicating “downloaded” of the document to the management server 2 (ACT 84).

If the processor 11 of the user terminal 1 receives a notification to the effect that overwrite download is performed concerning certain document data (YES in ACT 85), the processor 11 requests the management server 2 to download the document data (document data of the latest version) in a state in which the document data that should be overwritten (a replacement source document) is specified (ACT 86). In this case, the processor 11 overwrites the replacement source document data with the document data downloaded from the management server 2 (ACT 87). When the overwrite download is completed, the processor 11 uploads, to the management server 2, information indicating that the document data is downloaded (ACT 84).

If the processor 11 of the user terminal 1 receives a notification to the effect that certain document data is downloaded together with replacement information (YES in ACT 88), the processor 11 requests the management server 2 to download the document data (document data of the latest version) and replacement information of the document data (ACT 89). In this case, the processor 11 stores, while keeping the replacement source document data, the document data downloaded from the management server 2 and replacement data of the document data in the HDD 14 (ACT 90). When such download is completed, the processor 11 uploads, to the management server 2, information indicating that the document is already downloaded (ACT 84).

The processing in ACT 84 may be processing for notifying the management server 2 of the completion of the download. In this case, the processor 21 of the management server 2 only has to update the viewing history information of the history database 24e according to the notification of the completion of the download.

With the processing explained above, the management server selectively downloads replacement information together with document data in response to a request from the user terminal. Consequently, the user terminals can download the replacement information according to a viewing situation of a document according to a notification from the management server.

The management server updates the viewing history information stored in the history database every time the management server downloads document data to the user terminal. The management server updates the viewing history information stored in the history database every time the management server acquires information indicating “viewed (opened)” of downloaded document data from the user terminal. Consequently, the management server can update viewing history information for the users of documents according to situations in the user terminals.

The user terminal 1 includes the user history database 14a that manages information such as a download situation and a viewing situation (viewing history information) for document data for which a download notification is received from the management server 2. The user history database 14a stores viewing history information for documents of the user of the user terminal 1. In the user history database 14a, state information of the viewing history information is not limited to “un-downloaded”, “downloaded”, and “viewed (opened)” and could be “updated (replaced)”.

For example, if the user terminal 1 receives a download notification from the management server 2, the user terminal 1 stores viewing history information for document data, the download of which is notified, in the user history database 14a. For example, when the user terminal 1 receives a download notification, the processor 11 of the user terminal 1 sets state information of the viewing history information of the document data stored in the user history database 14a as “un-downloaded”.

If the download of the document data is completed according to the processing explained above, the processor 11 of the user terminal 1 notifies the management server 2 that the document data is already downloaded. The processor 11 updates, in the user history database 14a, the state information of the viewing history information of the document data to “downloaded”.

If the processor 11 of the user terminal 1 displays the document data according to viewing processing explained later, the processor 11 of the user terminal 1 notifies the management server 2 that the document data is viewed (opened). The processor 11 updates, in the user history database 14a, the state information of the viewing history information of the document data to “viewed (opened)”.

If the processor 11 of the user terminal 1 receives a notification to the effect that replacement information is downloaded together with the document data according to the processing explained above (receives a download notification including “replaced”), the processor 11 updates, in the user history database 14a, the state information of the viewing history information of the document data to “updated (replaced)”. In other words, if the processor 11 receives a download notification including “replaced”, the user history database 14a stores the state information of the viewing history information of the document data as “viewed (opened)”. Therefore, the processor 11 of the user terminal 1 updates, according to the reception of the download notification including “replaced”, the processor 11 updates the state information of the viewing history information of the document data from “viewed (opened)” to “updated (replaced)”.

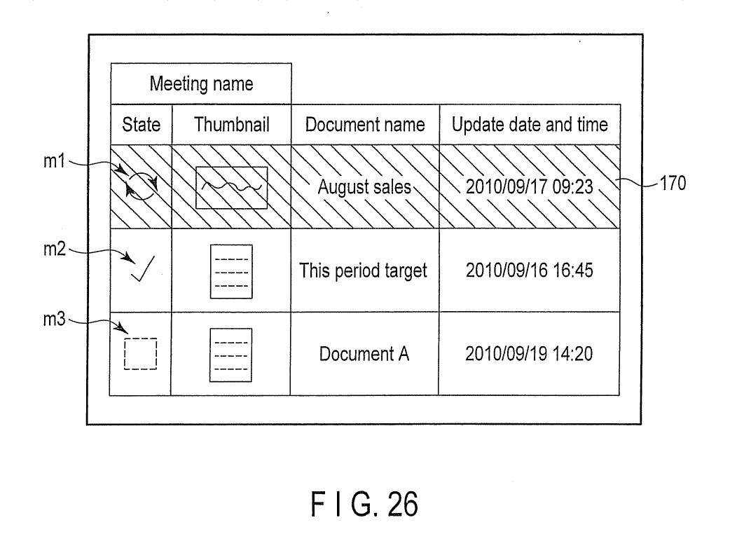

The processor 11 of the user terminal 1 includes a function of displaying, on the display section 16, state information of viewing history information of document data stored in the user history database 14a. For example, the processor 11 displays, as a list, icons indicating download situations and viewing situations (any one of “un-downloaded”, “downloaded”, “viewed”, and “updated (replaced)) concerning documents (see, for example, FIG. 26).

Viewing processing for a document in the user terminal 1 is explained.

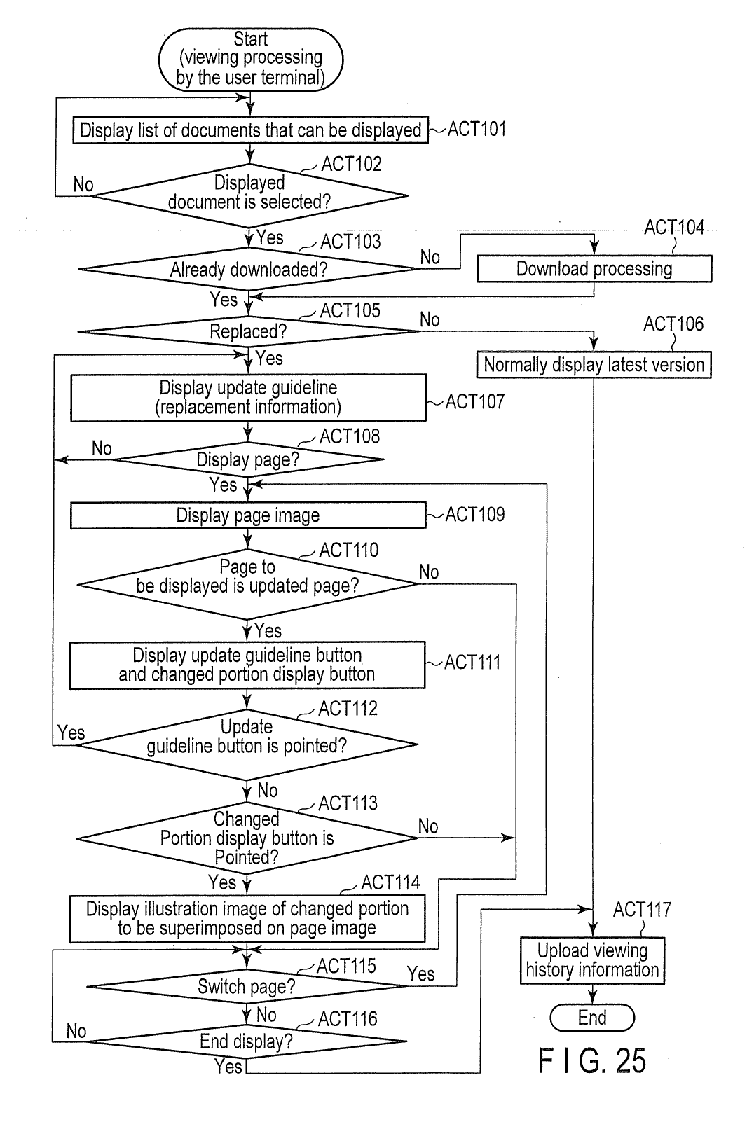

FIG. 25 is a flowchart for explaining a flow of the viewing processing for a document in the user terminal 1. Processing for viewing document data downloaded from the management server 2 by the user terminal 1 is explained.

First, the processor 11 of the user terminal 1 displays, on the display section 16, a list of documents that the user of the user terminal 1 can view (display) (ACT 101). The list of documents that can be viewed only has to be a list of document data, a download notification for which is received from the management server 2. The processor 11 may inquire the management server 2 about document data that the user can view and may acquire, from the management server 2, a list of the document data that the user can view.

FIG. 26 is a diagram of a display example of a document list screen 170 on which a list of documents that the user can view (display) is displayed. In the display example of the document list screen 170 shown in FIG. 26, the processor 11 displays state icons, thumbnails, document names, and update date and times concerning the documents that the user can view (display). The user selects the documents displayed on the document list screen 170 by pointing display regions in display spaces. For example, if the user terminal 1 is an apparatus including a display device incorporating a touch panel, the user can select a desired document by directly touching a display space of the document. For example, in the display example shown in FIG. 26, a document having a document name “August sales” is selected.

In the display example shown in FIG. 26, the display section 16 displays an update icon m1, a “downloaded” icon m2, and an “un-downloaded” icon 3m as state icons indicating states of each document. The update icon m1 is an icon in which a mark indicating that the document is updated (replaced) is displayed. The update icon m1 is displayed if viewing history information indicating that the user already views replacement source document data is present. In other words, the update icon m1 is a mark for urging the user to view updated document data (document data of the latest version).

The “downloaded” icon m2 is an icon in which a mark indicating that the document data is downloaded is displayed. A document for which the “downloaded” icon m2 is displayed can be immediately displayed on the display section 16. The “un-downloaded” icon m3 is an icon on which a mark indicating that the document data is not downloaded yet is displayed. The document data needs to be downloaded from the management server 2 to display, on the display section 16, a document for which the “un-downloaded” icon m3 is displayed. On the document list screen, besides the three icons, an icon indicating “viewed (opened)” may be displayed as an icon indicating a state of a document.

If one document is selected from the list of documents shown in FIG. 26 (YES in ACT 102), the processor 11 determines whether selected document data is already downloaded to the user terminal 1 (ACT 103). If the selected document data is not downloaded yet (NO in ACT 103), the processor 11 performs download processing for downloading the selected document data from the management server 2 (ACT 104).

If the selected document data is downloaded (YES in ACT 103) or if the download from the management server 2 is completed, the processor 11 determines whether replacement setting is present in the document data (replacement source document data) (ACT 105).

If the processor 11 determines that replacement setting is absent (NO in ACT 105), the processor 11 displays the selected document data on the display section 16 (ACT 106). When the document is displayed, in order to update the viewing history information for the document of the user, the processor 11 uploads information indicating that the document is already viewed (opened) to the management server 2 (ACT 115).

If the processor 11 determines that replacement setting is present (YES in ACT 105), the processor 11 displays on the display section an update guideline for the document (ACT 107). The update guideline is guidance for replaced content. The update guideline is displayed on the basis of replacement information of the document data. For example, the processor 11 displays, as the update guideline, a replacement comment indicating replaced content for the document and an updated page on the display section 16. If the processor 11 determines that replacement setting is present (YES in ACT 105), the processor 11 may proceed to ACT 109 skipping ACTS 107 and 108 and displays a page image of the document data.

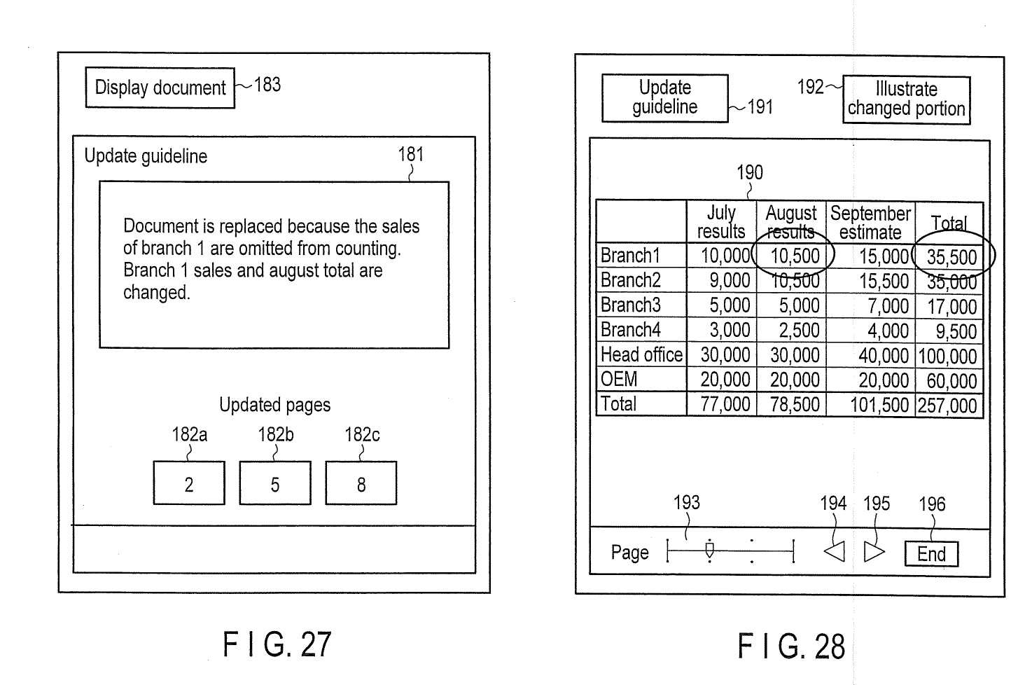

FIG. 27 is a diagram of a display example of the update guideline. In the display example shown in FIG. 27, the display section 16 displays, as the update guideline, a replacement comment indicating replaced content or the like in a display space 181. Further, in the display example shown in FIG. 27, the display section 16 displays thumbnail images 182a, 182b, and 182c based on pages images of updated pages. The thumbnail images 182a, 182b, and 182c of the updated pages may be icons for instructing display of the updated pages. In this case, when the thumbnail image 182a, 182b, or 182c of any one of the updated pages is pointed, the processor 11 displays a page image of the pointed updated page on the display section 16.

In the display example of the update guideline shown in FIG. 27, the display section 16 also displays an icon 183 for switching the display to display of normal document data (display of the page image). If the icon 183 is displayed, the processor 11 displays the page image of the document data on the display section 16.

If the display of the page image is instructed (YES in ACT 108), the processor 11 displays the page image of the document data on the display section 16. If the pages to be displayed are the updated pages, the processor 11 displays the page image (ACT 109). If the page image is displayed, the processor 11 determines whether the page image to be displayed is the updated page (ACT 110). If the page image to be displayed is the updated page (YES in ACT 110), the processor 11 displays an icon for instructing display of the update guideline (an update guideline button) and an icon for instructing display of a changed portion (a changed portion illustration button) on the display section 16 together with the page image (ACT 111).

FIG. 28 is a diagram of a display example in which the page image of the updated page is displayed. In the display example shown in FIG. 28, the display section 16 displays an update guideline button 191, a changed portion illustration button 192, a slide bar 193, a previous page button 194, a next page button 195, and an end button 196, together with an updated page image 190.

The update guideline button 191 is a button for instructing switching to the display of the update guideline. The changed portion illustration button 192 is a button for instructing the display section 16 to display the illustration image (in the example shown in FIG. 3, CommentPage001.GIF) indicating the changed portion stored as the replacement data to be superimposed on the page image.

The slide bar 193 is a slide bar for switching a page to be displayed. The previous page button 194 is a button for instructing the display section 16 to switch the page to be displayed to a previous page. The next page button 195 is a button for instructing the display section 16 to switch the page to be displayed to the next page. The user may instruct the switching to the previous page or the next page by touching a display portion of the page image while sliding the display portion in the left direction or the right direction. The end button 196 is a button for instructing an end of the display of the document data.

If the update guideline button 191 is pointed on the display screen shown in FIG. 28 (YES in ACT 112), the processor 11 proceeds to ACT 107 and displays the update guideline for the document on the display section 16. If the changed portion illustration button 192 is on (YES in ACT 113), the processor 11 causes the display section 16 to display an illustration image of a changed portion to be superimposed on the displayed image images (ACT 114).

If an instruction for page switching is input in a state in which the page image is displayed (YES in ACT 115), the processor 11 returns to ACT 109 and displays the designated page image. If the end of the display of the document data is instructed (YES in ACT 116), the processor 11 ends the display of the document. In order to update the viewing history information for the document of the user, the processor 11 uploads information indicating that the document is already viewed (opened) to the management server 2 (ACT 117).

With the processing explained above, the user terminal displays the update guideline if replacement source document data is present for document data to be displayed. If the user terminal displays a page image of an updated page, the user terminal displays, together with the page image, the button for causing the display section to display the update guideline and a button for causing the display section to display illustration of a changed portion. Consequently, even if replacement occurs in viewed document data, the user can check the update guideline and check the changed portion in the updated page through illustration.

A processing example in displaying document data on the Web page is explained. In the processing example shown in FIGS. 22 to 25, it is assumed that document data is downloaded from the management server 2 to the user terminal 1 and the user terminal 1 opens the downloaded document data. As a modification of the processing, it is also possible to carry out a form in which the management server 2 causes a logged-in user to display document data on the Web page managed by the management server 2. If document data is displayed on the Web, the state information of the viewing history information stored in the history database 24e is “viewed (opened)” or “unviewed (unopened)”.

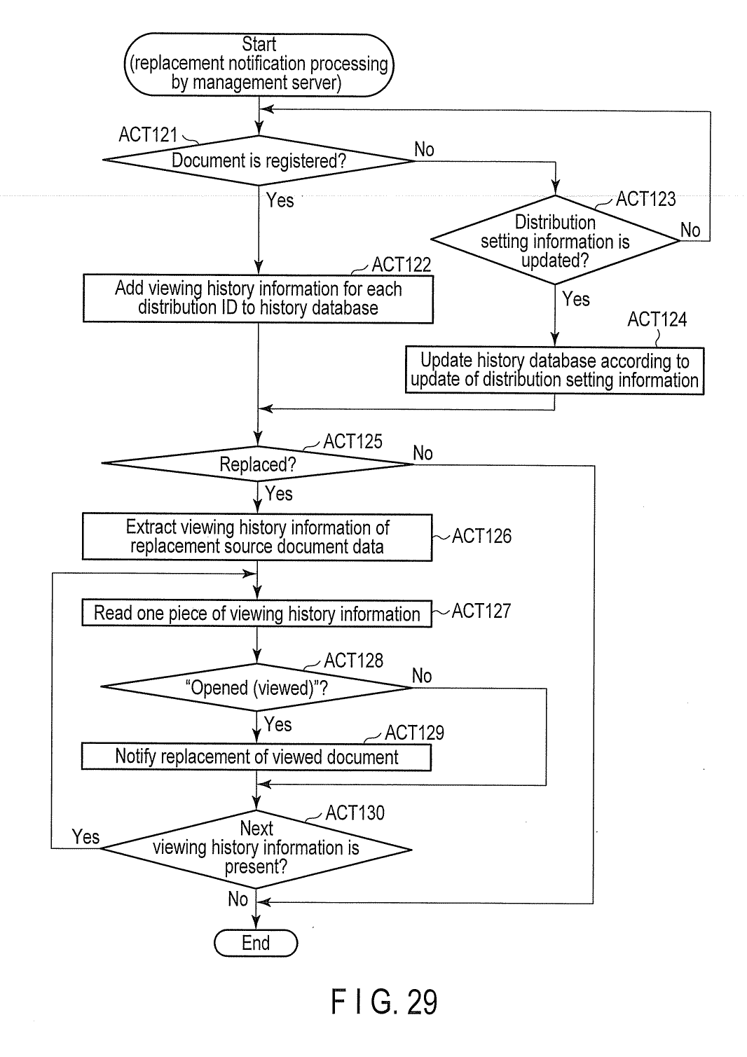

FIG. 29 is a flowchart for explaining a flow of replacement notification processing in the management server 2 in displaying document data with the Web.

The processor 21 of the management server 2 determines on the basis of a registration situation of a job file in the job storing section 24a or an update situation of the job management database 24b whether document data is registered anew (ACT 121). If the processor 21 determines that document data is registered (YES in ACT 121), the processor 21 adds a storage area for storing viewing history information for the document data registered anew to the history database 24e (ACT 122).

The processor 21 determines on the basis of an update situation of the job file in the job storing section 24a or an update situation of the job management database 24b whether distribution setting information for the registered document data is updated (ACT 123). If the processor 21 determines that the distribution setting information for the document data is updated (YES in ACT 123), the processor 21 updates the history database 24e according to update content of the distribution setting information (ACT 124). For example, if a distribution ID is added to the registered document data, the processor 21 adds a storage area for storing viewing history information corresponding to the added distribution ID to the history database 24e.

If a document is registered anew or the distribution setting information is updated, the processor 21 determines whether replacement for the document registered anew is designated or replacement for the document, the distribution setting information of which is updated, is designated anew (ACT 125).

If the processor 21 determines that replacement is designated anew (YES in ACT 125), the processor 21 extracts all pieces of viewing history information of distribution ID for the replacement source document data from the history database 24e (ACT 126). When the viewing history information of the distribution ID for the replacement source document data is extracted, the processor 21 reads one piece of viewing history information (for one distribution ID) (ACT 127). The processor 21 determines whether state information in the read viewing history information is “viewed” (ACT 128).

If the processor 21 determines that the state information of the read viewing history information is “unviewed” (No in ACT 128), the processor 21 checks whether the next viewing history information (viewing history information for another distribution ID), for which viewing check is not performed, in the viewing history information extracted in ACT 126 is present (ACT 130). If the next viewing history information is present (YES in ACT 130), the processor 21 performs the processing from ACT 127 on the basis of the next viewing history information.

If the processor 21 determines that the state information of the read viewing history information is “viewed” (NO in ACT 128), the processor 21 notifies distribution ID of the viewing history information that replacement occurs in the viewed document and replacement document data (document data of the latest version) is registered anew (ACT 129). When the processor 21 notifies one distribution ID of the replacement of the viewed document, the processor 21 checks whether the next viewing history information (viewing history information for another distribution ID), for which viewing check is not performed, in the viewing history information extracted in ACT 126 is present (ACT 130). If the next viewing history information is present (YES in ACT 130), the processor 21 performs the processing from ACT 127 on the basis of the next viewing history information.

With the processing explained above, the management server notifies distribution IDs (user terminals), which already view the replacement source document, that replacement occurs in the viewed document and that document data replacing the viewed document data (document data of the latest version) is registered. Consequently, concerning the document in which replacement occurs, the management server can urge, by notifying a user who already views the document that the replacement occurs, the user to view the document of the latest version.

Display processing and viewing management processing for document data by the management server 2 are explained.

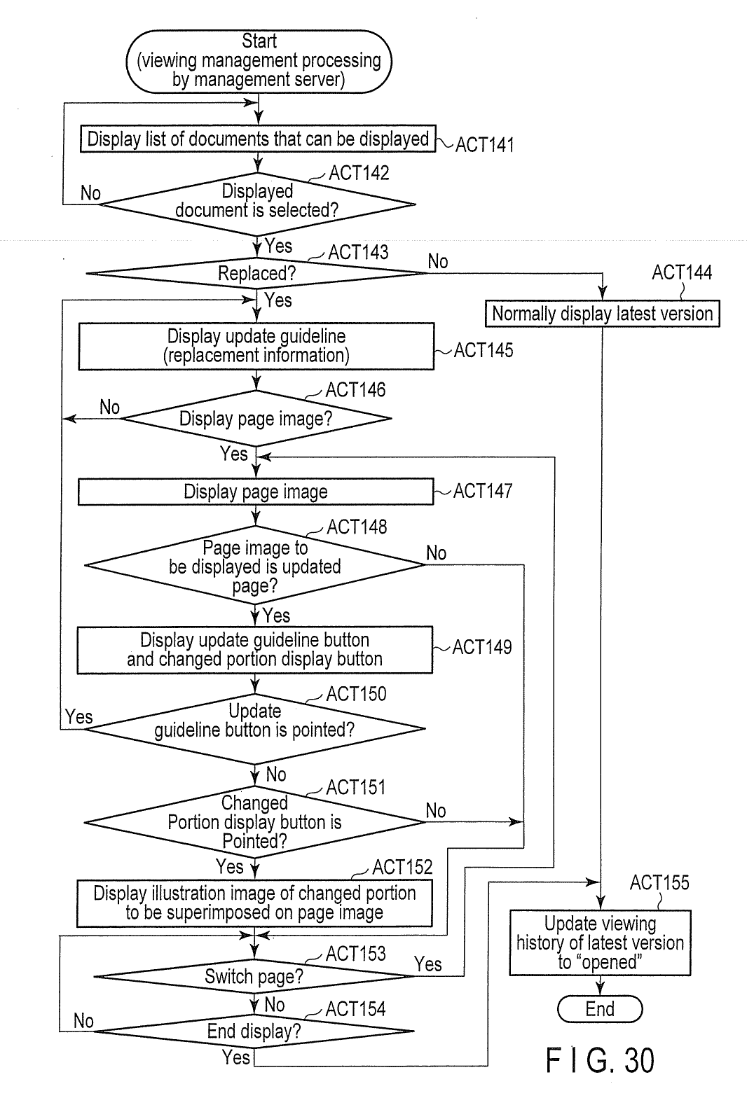

FIG. 30 is a flowchart for explaining a flow of the display processing and the viewing management processing for a document by the management server 2. Processing for displaying document data requested from a user terminal on a Web page provided by the management server 2 is explained.

First, the processor 21 of the management server 2 displays a list of documents that a user who logs in to a Web page accessible by the logged-in user terminal 1 can view (display) (ACT 141). For example, as shown in FIG. 26, the processor 21 displays the list of the documents that the user can view (display) as a document selection screen on which the documents can be selected. The document selection screen may be, for example, a display example shown in FIG. 26. However, in a form of displaying a document on the Web page, as states of the documents in the display example shown in FIG. 26, marks indicating any one of update, viewed, and unviewed are displayed.

If one document is selected from the list of the documents that the user can view (YES in ACT 142), the processor 11 determines whether replacement source document data is present for selected document data (ACT 143).

If the processor 11 determines that replacement source document data is absent (NO in ACT 143), the processor 11 displays a page image of the selected document data on the display section 16 (ACT 144). When the document is displayed, the processor 21 updates state information in viewing history information for the document of the user to “viewed” (ACT 155).

If the processor 11 determines that replacement source document data is present (YES in ACT 143), the processor 11 displays an update guideline for the document on the Web page accessed by the user terminal 1 (ACT 145). The update guideline is based on replacement data of the document data. For example, the update guideline is displayed in the display example shown in FIG. 27. If the processor 11 determines that replacement source document data is present (YES in ACT 143), the processor 11 may proceed to ACT 147 skipping ACT 145 and display a page image of the document data.

If display of a page image is instructed (YES in ACT 146), the processor 21 displays a page image of the document data on the Web page accessed by the user terminal 1 (ACT 147). If the page image is displayed, the processor 11 determines whether the page image to be displayed is an updated page (ACT 148). If the page to be displayed is an updated page (YES in ACT 148), the processor 11 displays an update guideline button and a changed portion display button together with the page image (ACT 149). For example, as in the display example shown in FIG. 28, the update guideline button and the changed portion display button only have to be displayed together with the page image.

If the update guidelines button is pointed on the display screen (YES in ACT 150), the processor 21 proceeds to ACT 145 and displays the update guideline for the document. If the changed portion illustration button is pointed (YES in ACT 151), the processor 21 displays an illustration image of a changed portion to be superimposed on the displayed page image (ACT 152).

If an instruction for page switching is input in a state in which the page image is displayed (YES in ACT 153), the processor 21 returns to ACT 147 and displays the designated page image. If an end of the display of the document data is instructed (YES in ACT 154), the processor 21 ends the display of the document and updates the state information in the viewing history information for the document of the user to “viewed” (ACT 155).

With the processing explained above, the management server displays the update guideline if replacement source document data is present for document data to be displayed on the Web page. If a page image of an updated page is displayed, the management server displays, together with the page image, a button for displaying the update guideline and a button for displaying illustration of a changed portion. Consequently, even if replacement occurs in a viewed document data, the user can check the update guideline and check a changed portion in the updated page according to the illustration.

As explained above, if replacement (a change) occurs in a part of a distributed document, the document distributing system according to this embodiment sets, in document data of the latest version, a comment indicating replaced content, image data illustrating a changed portion on an updated page, and the like as replacement data. Consequently, if a document in which replacement occurs is displayed, it is possible to plainly present a replaced portion or the like to the user by presenting the replacement data.

If replacement document data is registered anew, the document distribution system according to this embodiment causes a user who does not view a replacement source document to download document data of the latest version without causing the user to download the replacement source document and download the document data of the latest version to overwrite the downloaded replacement source document. As a result, with this system, it is possible to prevent disorder due to replacement and surely distribute a desired document (a document of the latest version) to the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server apparatus comprising:
a first storing section configured to store document data;
a second storing section configured to store information indicating a distribution ID of the document data;
an input section configured to receive replacement information indicating replaced content if old document data stored by the first storing section is replaced with new document data;
a third storing section configured to store the replacement information received by the input section in association with the new document data; and
a distributing section configured to distribute the new document data and the replacement information, in response to a request from an apparatus which has the distribution ID.

2. The apparatus according to claim 1, wherein the input section receives replacement information included in information uploaded from a terminal apparatus together with document data.

3. The apparatus according to claim 1, wherein the input section receives replacement information input to an accessible Web page from a terminal apparatus.

4. The apparatus according to claim 1, wherein the third storing section stores the replacement information and replacement information including text information concerning replacement of document data.

5. The apparatus according to claim 1, wherein the third storing section stores replacement information including image data illustrating a changed portion in the replaced document data.

6. The apparatus according to claim 5, wherein the image data illustrating the changed portion is image data displayed to be superimposed on the replaced page image.

7. A server apparatus comprising:
a first storing section configured to store document data;
a second storing section configured to store distribution ID of the document data;
a history database configured to store a viewing state of the document data for each of the distribution ID;
a third storing section configured to store replacement information associated with the document data;
a transmitting section configured to transmit a notification corresponding to a viewing state of a replacement source document to each of the distribution ID of the document data associated with the replacement information; and
a distributing section configured to distribute the document data and the replacement information to the distribution ID, in response to a request from an apparatus which has the distribution ID to which the notification is transmitted by the transmitting section.

8. The apparatus according to claim 7, wherein
the transmitting section transmits download guidance for the document data corresponding to the viewing state of the replacement source document to a distribution ID terminal apparatus, and
the distributing section downloads, in response to a request from the distribution ID terminal apparatus to which the download guidance is transmitted by the transmitting section, the document data and the replacement information to the terminal apparatus.

9. The apparatus according to claim 8, wherein the transmitting section transmits, together with the document data, guidance for urging download of the replacement information to the distribution ID that already views the replacement source document.

10. The apparatus according to claim 8, wherein the transmitting section transmits guidance for urging download of the document data to the distribution ID that does not download the replacement source document yet.

11. The apparatus according to claim 8, wherein the transmitting section transmits guidance for urging overwrite download of the document data to the distribution ID that already downloads the replacement source document and does not view the replacement source document yet.

12. The apparatus according to claim 7, wherein
the transmitting section transmits a notification to the effect that viewed document data is replaced to the distribution ID that already views the replacement source document, and
the distributing section displays new document data on a Web page accessible by a user of the distribution ID that transmits the notification with the transmitting section.

13. The apparatus according to claim 12, wherein the distributing section displays the replacement information on the Web page together with the new document data.

14. The apparatus according to claim 13, wherein the distributing section displays an update guideline, which can be switched to the display of the new document data, on the Web page on the basis of the replacement information.

15. The apparatus according to claim 13, wherein the distributing section displays page images of the new document data on the Web page in order and displays an illustration image of a changed portion to be superimposed on a page image of a replaced updated page.

16. The apparatus according to claim 15, wherein the distributing section displays, if the page image of the updated page is displayed, an icon for switching on and off of the illustration image of the changed portion.

17. A non-transitory computer readable medium containing program instructions for:
storing document data;
storing distribution ID of the document data;
storing a viewing state of the document data in a history database for each of the distribution ID;
storing replacement information associated with the document data;
transmitting a notification corresponding to a viewing state of a replacement source document to each of the distribution ID of the document data associated with the replacement information; and
distributing, in response to a request from an apparatus which has the distribution ID to which the notification is transmitted, the document data and the replacement information to the apparatus which has distribution ID.

18. The medium according to claim 17, wherein
the transmitting a notification includes transmitting, as the notification, download guidance for the document data corresponding to the viewing state of the replacement source document to a distribution ID terminal apparatus, and
the distributing the document data and the replacement information includes downloading, in response to a request from the distribution ID terminal apparatus to which the download guidance is transmitted, the document data and the replacement information to the distribution ID terminal apparatus.

19. The medium according to claim 17, wherein
the transmitting a notification includes transmitting a notification to the effect that viewed document data is replaced to the distribution ID that already views the replacement source document, and
the distributing the document data and the replacement information includes displaying new document data on a Web page accessible by a user of the distribution ID that transmits the notification.

20. The medium according to claim 19, wherein the distributing the document data and the replacement information includes displaying the replacement information on the Web page together with the new document data.
